(19) United States
(12) Patent Application Publication
(10) Pub. No.: US 2018/0085920 A1
(43) Pub. Date: Mar. 29, 2018

(54) ROBOT CONTROL DEVICE, ROBOT, AND ROBOT SYSTEM

(71) Applicant: Seiko Epson Corporation, Tokyo (JP)

(72) Inventor: Yoshihito YAMADA, Chino (JP)

(21) Appl. No.: 15/712,719

(22) Filed: Sep. 22, 2017

(30) Foreign Application Priority Data
Sep. 27, 2016 (JP) 2016-187875

(51) Int. Cl. B25J 9/16

(52) U.S. Cl. CPC B25J 9/1635; B25J 9/163; B25J 9/1633; B25J 9/1682

(57) ABSTRACT

A robot control device moves an arm, which includes seven or more axes, included in a robot on the basis of usability information in which usable arm postures are determined among a plurality of arm postures that the arm can take when an arm position associated with the arm coincides with a target position serving as a target for changing the arm position.

### BACKGROUND

### 1. Technical Field

The present invention relates to a robot control device, a robot, and a robot system.

### 2. Related Art

A technique for controlling a robot including an arm that operates at a degree of freedom of seven or more axes has been researched and developed.

Concerning the technique, there is known a control method for a robot including a manipulator formed by coupling a plurality of links with joint axes to have at least one redundant degree of freedom with respect to a degree of freedom of work, the joint axes being driven by rotary system actuators provided for each of the joint axes. The control method includes calculating load torque based on at least inertial forces, centrifugal forces, and Coriolis forces of the joint axes of the links and the gravity at the time when link positions and link postures allowed by the redundant degree of freedom are changed under a constraint condition in which a hand tip position/posture is set as a target value, acquiring link positions and link postures in which the load torque and a rated torque ratio of the rotary system actuators are minimized among the changed link positions and link postures, and giving, to a control command for the rotary system actuators of the joint axes in which the hand tip position/posture is set as the target value, feed-forward values serving as load torques at the time when the load torque and the rated torque ratio of the rotary system actuators are minimized (see JP-A-2013-193131 (Patent Literature 1)).

However, in the control method, the calculated link positions and postures sometimes do not coincide with link positions and link postures desired by a user.

### SUMMARY

An aspect of the invention is directed to a robot control device that moves an arm, which includes seven or more axes, included in a robot on the basis of usability information in which usable arm postures are determined among a plurality of arm postures that the arm can take when an arm position associated with the arm coincides with a target position serving as a target for moving the arm position.

According to this configuration, the robot control device moves the arm, which includes the seven or more axes, included in the robot on the basis of the usability information in which the usable arm postures are determined among the plurality of arm postures that the arm can take when the arm position associated with the arm coincides with the target position serving as the target for changing the arm position. Consequently, the robot control device can move the arm while matching the arm posture of the robot with an arm posture desired by a user.

In another aspect of the invention, the robot control device may be configured such that the usability information is information in which possibility information indicating usability or unusability is associated with arm posture information indicating each of the plurality of arm postures.

According to this configuration, in the robot control device, the usability information is the information in which the possibility information indicating usability or unusability is associated with the arm posture information indicating each of the plurality of arm postures. Consequently, the robot control device can move the arm while matching the arm posture of the robot with the arm posture desired by the user on the basis of the usability information in which the possibility information indicating usability or unusability is associated with the arm posture information indicating each of the plurality of arm postures.

In another aspect of the invention, the robot control device may be configured such that the robot control device stores the arm posture information received by the robot control device and not included in the usability information in the usability information in association with the possibility information received by the robot control device.

According to this configuration, the robot control device stores the arm posture information received by the robot control device and not included in the usability information in the usability information in association with the possibility information received by the robot control device. Consequently, the robot control device can move the arm while matching the arm posture of the robot with the arm posture desired by the user on the basis of the received arm posture information and the received possibility information.

In another aspect of the invention, the robot control device may be configured such that the robot control device stores the arm posture information not included in the usability information in the usability information in association with the possibility information associated with the arm posture information that indicates the arm posture closest to the arm posture indicated by the arm posture information not included in the usability information and is included in the usability information.

According to this configuration, the robot control device stores the arm posture information not included in the usability information in the usability information in association with the possibility information associated with the arm posture information that indicates the arm posture closest to the arm posture indicated by the arm posture information not included in the usability information and is included in the usability information. Consequently, the robot control device can move the arm while matching the arm posture of the robot with the arm posture desired by the user on the basis of the arm posture information indicating the arm posture closest to the arm posture indicated by the arm posture information not included in the usability information.

In another aspect of the invention, the robot control device may be configured such that the robot control device specifies likely possibility information as the possibility information associated with the arm posture indicated by the arm posture information not included in the usability information and stores the specified possibility information in the usability information in association with the arm posture information indicating the arm posture.

According to this configuration, the robot control device specifies the likely possibility information as the possibility information associated with the arm posture indicated by the arm posture information not included in the usability information and stores the specified possibility information in the usability information in association with the arm posture information indicating the arm posture. Consequently, the robot control device can move the arm while matching the arm posture of the robot with the arm posture desired by the user on the basis of the likely possibility information specified as the possibility information associated with the arm posture indicated by the arm posture information not included in the usability information.

In another aspect of the invention, the robot control device may be configured such that the robot control device specifies the likely possibility information on the basis of one or more parameters representing the arm posture indicated by the arm posture information not included in the usability information.

According to this configuration, the robot control device specifies the likely possibility information as the possibility information associated with the arm posture on the basis of one or more parameters representing the arm posture indicated by the arm posture information not included in the usability information. Consequently, the robot control device can move the arm while matching the arm posture of the robot with the arm posture desired by the user on the basis of the one or more parameters representing the arm posture indicated by the arm posture information not included in the usability information.

Another aspect of the invention is directed to a robot controlled by the robot control device described above.

According to this configuration, the robot moves the arm, which includes the seven or more axes, included in the robot on the basis of the usability information in which the usable arm postures are determined among the plurality of arm postures that the arm can take when the arm position associated with the arm coincides with the target position serving as the target for changing the arm position. Consequently, the robot can move the arm while matching the arm posture of the robot with an arm posture desired by a user.

Still another aspect of the invention is directed to a robot system including: the robot control device described above; and the robot controlled by the robot control device.

According to this configuration, the robot system moves the arm, which includes the seven or more axes, included in the robot on the basis of the usability information in which the usable arm postures are determined among the plurality of arm postures that the arm can take when the arm position associated with the arm coincides with the target position serving as the target for changing the arm position. Consequently, the robot system can move the arm while matching the arm posture of the robot with an arm posture desired by a user.

As explained above, the robot control device, the robot, and the robot system move the arm, which includes the seven or more axes, included in the robot on the basis of the usability information in which the usable arm postures are determined among the plurality of arm postures that the arm can take when the arm position associated with the arm coincides with the target position serving as the target for changing the arm position. Consequently, the robot control device, the robot, and the robot system can move the arm while matching the arm posture of the robot with an arm posture desired by a user.

### BRIEF DESCRIPTION OF THE DRAWINGS

The invention will be described with reference to the accompanying drawings, wherein like numbers reference like elements.

FIG. 1 is a diagram showing an example of the configuration of a robot system according to an embodiment.

FIG. 2 is a diagram showing an example of a hardware configuration of a robot control device.

FIG. 3 is a diagram showing an example of a functional configuration of the robot control device.

FIG. 4 is a flowchart for explaining an example of a flow of processing in which the robot control device generates first usability information.

FIG. 5 is a diagram showing an example of a determination screen.

FIG. 6 is a diagram showing an example of the first usability information stored in a storing section.

FIG. 7 is a flowchart for explaining a flow of a specific example 1 of processing in which the robot control device causes a robot to perform predetermined work.

FIG. 8 is a flowchart for explaining an example of a flow of processing by the robot control device that performs machine learning of a target correspondence relation.

FIG. 9 is a diagram showing an example of post-conversion first usability information.

FIG. 10 is a diagram showing an example of a logical structure of a first arm.

FIG. 11 is a diagram showing an example of parameter information.

FIG. 12 is a flowchart for explaining another example of the flow of the processing in which the robot control device causes the robot to perform the predetermined work.

### DESCRIPTION OF EXEMPLARY EMBODIMENTS

### Embodiment

An embodiment of the invention is explained below with reference to the drawings.

### Configuration of a Robot System

First, the configuration of a robot system 1 is explained.

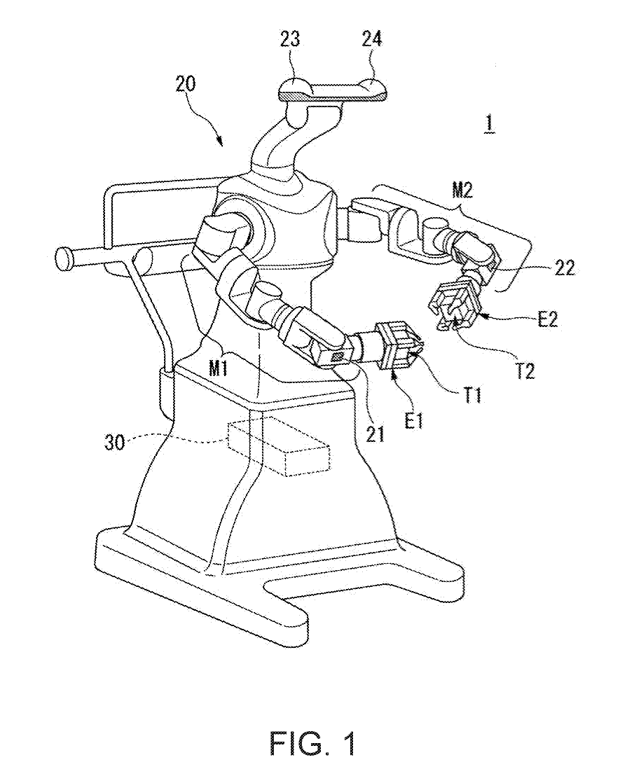

FIG. 1 is a diagram showing an example of the configuration of the robot system 1 according to an embodiment. The robot system 1 includes a robot 20 incorporating a robot control device 30. Note that the robot system 1 may include, in addition to the robot 20, other devices separate from the robot 20 such as an image pickup section separate from the robot 20 and a teaching device (a teaching pendant) separate from the robot 20.

The robot 20 is a double-arm robot including a first arm, a second arm, a supporting stand that supports the first arm and the second arm, and the robot control device 30 on the inner side of the supporting stand. Note that, instead of the double-arm robot, the robot 20 may be a plural-arm robot including three or more arms or may be a single-arm robot including one arm. The robot 20 may be another robot such as a horizontal multi-joint robot.

The first arm includes a first end effector E1 and a first manipulator M1. Note that, instead of this, the first arm may include only the first manipulator M1 without including the first end effector E1. The first arm may include a force detecting section (e.g., a force sensor or a torque sensor).

In this example, the first end effector E1 is an end effector including a finger section capable of gripping an object. Note that, instead of the end effector including the finger section, the first end effector E1 may be an end effector capable of lifting an object with suction of the air, a magnetic force, a jig, or the like or other end effectors.

The first end effector E1 is communicably connected to the robot control device 30 by a cable. Consequently, the first end effector E1 performs operation based on a control signal acquired from the robot control device 30. Note that wired communication via the cable is performed according to a standard such as the Ethernet (registered trademark) or the USB (Universal Serial Bus). The first end effector E1 may be connected to the robot control device 30 by wireless communication performed according to a communication standard such as the Wi-Fi (registered trademark).

The first manipulator M1 includes not-shown seven joints J11 to J17 and a first image pickup section 21. Each of the joints J11 to J17 includes a not-shown actuator. That is, the first arm including the first manipulator M1 is an arm of a seven-axis vertical multi-joint type. The first arm performs operation having a degree of freedom of seven axes according to cooperated operation by the supporting stand, the first end effector E1, the first manipulator M1, and the actuators of the respective joints J11 to J17. Note that the first arm may operate at a degree of freedom of eight or more axes.

In this example, each of the joints J11, J13, J15, and J17 is a rotary joint (a torsional joint). The rotary joint is a joint that does not change an angle between two links connected to a turning shaft of the rotary joint according to turning of the turning shaft of the rotary joint. The link is a member included in the first manipulator M1 and connecting joints. Each of the joints J12, J14, and J16 is a swinging joint (a bending joint). The swinging joint is a joint that changes an angle between two links connected to a turning shaft of the swinging joint according to turning of the turning shaft of the swinging joint.

When the first arm operates at a degree of freedom of seven axes, postures that the first arm can take increase compared with when the first arm operates at a degree of freedom of six or less axes. Consequently, for example, the first arm can smoothly operate and can easily avoid interference with an object present around the first arm. When the first arm operates at a degree of freedom of seven axes, it is easy to control the first arm because computational complexity is small compared with when the first arm operates at a degree of freedom of eight or more axes.

The seven actuators included in the first manipulator M1 are respectively communicably connected to the robot control device 30 by cables. Consequently, the actuators operate the first manipulator M1 on the basis of a control signal acquired from the robot control device 30. Note that wired communication via the cables is performed according to a standard such as the Ethernet (registered trademark) or the USB. A part or all of the seven actuators included in the first manipulator M1 may be connected to the robot control device 30 by wireless communication performed according to a communication standard such as the Wi-Fi (registered trademark).

The first image pickup section 21 is a camera including, for example, a CCD (Charge Coupled Device) or a CMOS (Complementary Metal Oxide Semiconductor), which is an image pickup device that converts condensed light into an electric signal. In this example, the first image pickup section 21 is provided in a part of the first manipulator M1. Therefore, the first image pickup section 21 moves according to movement of the first arm. A range in which the first image pickup section 21 is capable of performing image pickup changes according to the movement of the first arm. The first image pickup section 21 may pick up a still image in the range or may pick up a moving image in the range.

The first image pickup section 21 is communicably connected to the robot control device 30 by a cable. Wired communication via the cable is performed according to a standard such as the Ethernet (registered trademark) or the USB. Note that the first image pickup section 21 may be connected to the robot control device 30 by wireless communication performed according to a communication standard such as the Wi-Fi (registered trademark).

The arm includes a second end effector E2 and a second manipulator M2. Note that, instead of this, the second arm may include only the second manipulator M2 without including the second end effector E2. The second arm may include a force detecting section (e.g., a force sensor or a torque sensor).

In this example, the second end effector E2 is an end effector including a finger section capable of gripping an object. Note that, instead of the end effector including the finger section, the second end effector E2 may be an end effector capable of lifting an object with suction of the air, a magnetic force, a jig, or the like or other end effectors.

The second end effector E2 is communicably connected to the robot control device 30 by a cable. Consequently, the second end effector E2 performs operation based on a control signal acquired from the robot control device 30. Note that wired communication via the cable is performed according to a standard such as the Ethernet (registered trademark) or the USB. The second end effector E2 may be connected to the robot control device 30 by wireless communication performed according to a communication standard such as the Wi-Fi (registered trademark).

The second manipulator M2 includes not-shown seven joints J21 to J27 and a second image pickup section 22. Each of the joints J21 to J27 includes a not-shown actuator. That is, the second arm including the second manipulator M2 is an arm of a seven-axis vertical multi-join type. The second arm performs operation having a degree of freedom of seven axes according to cooperated operation by the supporting stand, the second end effector E2, the second manipulator M2, and the actuators of the respective joints J21 to J27. Note that the second arm may operate at a degree of freedom of eight or more axes.

In this example, the joints J21, J23, J25, and J27 are respectively rotary joints (torsional joints). The rotary joint is a joint that does not change an angle between two links connected to a turning shaft of the rotary joint according to turning of the turning shaft of the rotary joint. The link is a member included in the second manipulator M2 and connecting joints. Each of the joints J22, J24, and J26 is a swinging joint (a bending joint). The swinging joint is a joint that changes an angle between two links connected to a turning shaft of the swinging joint according to turning of the turning shaft of the swinging joint.

When the second arm operates at a degree of freedom of seven axes, postures that the second arm can take increase compared with when the second arm operates at a degree of freedom of six or less axes. Consequently, for example, the second arm can smoothly operate and can easily avoid interference with an object present around the second arm. When the second arm operates at a degree of freedom of seven axes, it is easy to control the second arm because computational complexity is small compared with when the second arm operates at a degree of freedom of eight or more axes.

The seven actuators included in the second manipulator M2 are respectively communicably connected to the robot control device 30 by cables. Consequently, the actuators operate the second manipulator M2 on the basis of a control signal acquired from the robot control device 30. Note that wired communication via the cables is performed according to a standard such as the Ethernet (registered trademark) or the USB. A part or all of the seven actuators included in the second manipulator M2 may be connected to the robot control device 30 by wireless communication performed according to a communication standard such as the Wi-Fi (registered trademark).

The second image pickup section 22 is a camera including, for example, a CCD or a CMOS, which is an image pickup device that converts condensed light into an electric signal. In this example, the second image pickup section 22 is provided in a part of the second manipulator M2. Therefore, the second image pickup section 22 moves according to movement of the second arm. A range in which the second image pickup section 22 is capable of performing image pickup changes according to the movement of the second arm. The second image pickup section 22 may pick up a still image in the range or may pick up a moving image in the range.

The second image pickup section 22 is communicably connected to the robot control device 30 by a cable. Wired communication via the cable is performed according to a standard such as the Ethernet (registered trademark) or the USB. Note that the second image pickup section 22 may be connected to the robot control device 30 by wireless communication performed according to a communication standard such as the Wi-Fi (registered trademark).

The robot 20 includes a third image pickup section 23 and a fourth image pickup section 24.

The third image pickup section 23 is a camera including, for example, a CCD or a CMOS, which is an image pickup device that converts condensed light into an electric signal. The third image pickup section 23 is provided in a part where the third image pickup section 23 is capable of performing, in conjunction with the fourth image pickup section 24, stereoscopic image pickup in a range in which the fourth image pickup section 24 is capable of performing image pickup. The third image pickup section 23 is communicably connected to the robot control device 30 by a cable. Wired communication via the cable is performed according to a standard such as the Ethernet (registered trademark) or the USB. Note that the third image pickup section 23 may be connected to the robot control device 30 by wireless communication performed according to a communication standard such as the Wi-Fi (registered trademark).

The fourth image pickup section 24 is a camera including, for example, a CCD or a CMOS, which is an image pickup device that converts condensed light into an electric signal. The fourth image pickup section 24 is provided in a part where the fourth image pickup section 24 is capable of performing, in conjunction with the third image pickup section 23, stereoscopic image pickup in a range in which the third image pickup section 23 is capable of performing image pickup. The fourth image pickup section 24 is communicably connected to the robot control device 30 by a cable. Wired communication via the cable is performed according to a standard such as the Ethernet (registered trademark) or the USB. Note that the fourth image pickup section 24 may be connected to the robot control device 30 by wireless communication performed according to a communication standard such as the Wi-Fi (registered trademark).

In this example, the functional sections included in the robot 20 explained above acquire control signals from the robot control device 30 incorporated in the robot 20. The functional sections perform operations based on the acquired control signals. Note that, instead of incorporating the robot control device 30, the robot 20 may be controlled by the robot control device 30 set on the outside. In this case, the robot 20 and the robot control device 30 configure a robot system. The robot 20 may not include apart or all of the first image pickup section 21, the second image pickup section 22, the third image pickup section 23, and the fourth image pickup section 24.

In this example, the robot control device 30 is a controller that controls (operates) the robot 20. The robot control device 30 generates, for example, a control signal based on an operation program stored in advance. The robot control device 30 outputs the generated control signal to the robot 20 and causes the robot 20 to perform predetermined work. The predetermined work is, for example, work for gripping an object placed in a not-shown material supply region and placing the gripped object in a not-shown material removal region. Note that, instead of this, the predetermined work may be other work. Note that, instead of causing the robot 20 to perform the predetermined work on the basis of the operation program, the robot control device 30 may cause the robot 20 to perform the predetermined work according to visual servo, impedance control, or the like.

Overview of Processing in which the Robot Control Device Causes the Robot to Perform the Predetermined Work

An overview of processing in which the robot control device 30 causes the robot 20 to perform the predetermined work is explained below.

The robot control device 30 sets a first control point T1, which moves together with the first end effector E1, in a position associated with the first end effector E1 in advance. The position associated with the first end effector E1 in advance is, for example, the position of the center of gravity of the first end effector E1. The first control point T1 is, for example, a TCP (Tool Center Point) of the first arm. Note that, instead of the TCP, the first control point T1 may be another virtual point such as a virtual point associated with a part of the first manipulator M1. That is, instead of the position associated with the first end effector E1, the first control point T1 may be set in the position of another part of the first end effector E1 or may be set in any position associated with the first manipulator M1.

The robot control device 30 sets the first control point T1 on the basis of first control point setting information input from a user in advance. The first control point setting information is, for example, information indicating relative positions and postures of the position and the posture of the center of gravity of the first end effector E1 and the position and the posture of the first control point T1. Note that, instead of this, the first control point setting information may be information indicating relative positions and postures of some position and posture associated with the first end effector E1 and the position and the posture of the first control point T1, may be information indicating relative positions and postures of some position and posture associated with the first manipulator M1 and the position and the posture of the first control point T1, or may be information indicating relative positions and postures of some position and posture associated with another part of the robot 20 and the position and the posture of the first control point T1.

First control point position information, which is information indicating the position of the first control point T1, and first control point posture information, which is information indicating the posture of the first control point T1, are associated with the first control point T1. Note that other information may be associated with the first control point T1 in addition to these kinds of information.

In this example, the position of the first control point T1 is represented by a position in a robot coordinate system RC of the origin of a first control point coordinate system TC1. The posture of the first control point T1 is represented by directions in the robot coordinate system RC of coordinate axes in the first control point coordinate system TC1. The first control point coordinate system TC1 is a three-dimensional local coordinate system associated with the first control point T1 to move together with the first control point T1.

When operating the robot 20 on the basis of the operation program stored in advance, the robot control device 30 specifies, as a position and a posture serving as targets for changing the position and the posture of the first control point T1, for example, the position indicated by the first control point position information designated by the operation program and the posture indicated by the first control point posture information designated by the operation program. In the following explanation, for convenience of explanation, as long as it is unnecessary to distinguish the position and the posture of the control point T1, the position and the posture are collectively referred to as first arm position and explained. In the following explanation, as long as it is unnecessary to distinguish the position and the posture serving as the targets for changing the position and the posture of the first control point T1, the position and the posture are collectively referred to as first target position and explained. Note that the first arm position may be represented by only the position of the first control point T1. In this case, the first target position is represented by only the position serving as the target for changing the position of the first control point T1. The first arm position may be represented by another position and another posture based on the first arm or may be represented by only another position based on the first arm.

First redundant degree of freedom information indicating a first redundant degree of freedom is designated to the robot control device 30 together with the first control point position information and the first control point posture information by the operation program stored in advance.

The first redundant degree of freedom refers to a redundant degree of freedom of the first arm that operates at a degree of freedom of seven axes. In this example, the first redundant degree of freedom refers to an angle of a first target plane with respect to a first reference plane.

The first target plane refers to, when the first arm position coincides with a certain first target position, a plane including a triangle formed by connecting the joint J12, the joint J14, and the joint J16 among the joints of the first arm to one another with straight lines. More specifically, for example, in this case, the first target plane is a plane including a triangle formed by connecting the position of the center of gravity of the joint J12, the position of the center of gravity of the joint J14, and the position of the center of gravity of the joint J16 to one another with straight lines. Note that, instead of this, in this case, the first target plane may be a plane including a triangle formed by connecting another position of the joint J12, another position of the joint J14, and another position of the joint J16 to one another with straight lines.

In this case, the first reference plane refers to a plane including a triangle formed by connecting the joint J12, the joint J14, and the joint J16 to one another with straight lines and refers to the plane in the case in which a turning angle of each of the joints J12 and J16 coincides with a first predetermined turning angle. More specifically, for example, in this case, the first reference plane refers to a plane including a triangle formed by connecting the position of the center of gravity of the joint J12, the position of the center of gravity of the joint J14, and the position of the center of gravity of the joint J16 to one another with straight lines and refers to the plane in the case in which a turning angle of each of the joints J12 and J16 coincides with the first predetermined turning angle.

The first predetermined turning angle may be any turning angle. In this example, the first predetermined turning angle of the joint J12 and the first predetermined turning angle of the joint J16 are the same turning angle. However, instead of this, the first predetermined turning angles may be turning angles different from each other. Note that, instead of this, in this case, the first reference plane may be a plane including a triangle formed by connecting another position of the joint J12, another position of the joint J14, and another position of the joint J16 to one another with straight lines and may refer to the plane in the case in which a turning angle of each of the joints J12 and J16 coincides with the first predetermined turning angle.

The robot control device 30 specifies, as a first target redundant degree of freedom serving as a target for changing a first redundant degree of freedom of the first arm, the first redundant degree of freedom indicated by the first redundant degree of freedom information designated by the operation program.

The robot control device 30 calculates, according to inverse kinetics based on the first target position and the first target redundant degree of freedom specified in this way, turning angles in the case in which the first arm position coincides with the specified first target position and when the first redundant degree of freedom of the first arm coincides with the first target redundant degree of freedom, the turning angles being of the respective joints J11 to J17 included in the first arm. The robot control device 30 operates each of the joints J11 to J17, matches turning angles of the respective joints J11 to J17 with each of the calculated turning angles, and matches the first arm position with the calculated first target position. In this example, the first arm posture, which is the posture of the first arm, is represented by a combination of the turning angles of the respective joints J11 to J17. That is, the robot control device 30 calculates, according to inverse kinetics based on the specified first target position and the specified first target redundant degree of freedom, a first arm posture in the case in which the first arm position coincides with the specified first target position and in the case in which the first redundant degree of freedom of the first arm coincides with the first target redundant degree of freedom. The robot control device 30 operates each of the joints J11 to J17, matches the present first arm posture with the calculated first arm posture, and matches the present first arm position with the calculated first target position. In this way, the robot control device 30 can operate the first arm on the basis of the operation program. Note that the first arm posture may be represented by another value based on the first arm.

When causing the operation program to designate the first redundant degree of freedom to the robot control device 30, for example, there is known a method of causing the operation program to designate the first redundant degree of freedom information indicating the first redundant degree of freedom for minimizing a load applied to the actuators included in the first arm when matching the first arm position with the first target position indicated by the first control point position information and the first control point posture information.

However, when the operation program is caused to designate the first redundant degree of freedom information to the robot control device 30 by such a method, the first arm posture of the first arm operated by the robot control device 30 sometimes does not coincide with the first arm posture desired by the user. For example, when the shape of the robot 20 is a shape corresponding to the shape of a person as shown in FIG. 1 (i.e., the shape of the robot 20 is a shape similar to the shape of the person), the first arm posture desired by the user among the first arm postures is the first arm posture corresponding to a posture that the person can take among the first arm postures. When the first arm posture desired by the user and the first arm posture do not coincide with each other, the user sometimes recalls, for example, a situation in which a deficiency occurs in the robot 20, a situation in which the robot 20 causes interference with another object, or a situation in which the robot 20 causes interference with the robot 20 itself. As a result, the user causes the robot 20 to perform work while feeling uneasiness.

In order to prevent the user from feeling uneasiness, the robot control device 30 in this example moves the first arm on the basis of first usability information in which usable first arm postures are determined among a plurality of first arm postures that the first arm can take when the first arm position coincides with the first target position serving as the target for changing the first arm position associated with the first arm including seven or more axes included in the robot 20. The robot control device 30 causes the robot 20 to perform the predetermined work. The first usability information is information in which possibility information indicating usability or unusability is associated with first arm posture information indicating each of one or more first arm postures. The first usability information is an example of usability information. The first arm posture is an example of an arm posture. The first arm posture information is an example of arm posture information. Consequently, the robot control device 30 can move the first arm while matching the first arm posture of the robot 20 with the first arm posture desired by the user.

The robot control device 30 sets a second control point T2, which moves together with the second end effector E2, in a position associated with the second end effector E2 in advance. The position associated with the second end effector E2 in advance is, for example, the position of the center of gravity of the second end effector E2. The second control point T2 is, for example, a TCP of the second arm. Note that the second control point T2 may be, instead of the TCP, another virtual point such as a virtual point associated with a part of the second manipulator M2. That is, instead of the position associated with the second end effector E2, the second control point T2 may be set in the position of another part of the second end effector E2 or may be set in any position associated with the second manipulator M2.

The robot control device 30 sets the second control point T2 on the basis of second control point setting information input from the user in advance. The second control point setting information is, for example, information indicating the relative positions and postures of the position and the posture of the center of gravity of the second end effector E2 and the position and the posture of the second control point T2. Note that, instead of this, the second control point setting information may be information indicating relative positions and postures of some position and posture associated with the second end effector E2 and the position and the posture of the second control point T2, may be information indicating relative positions and postures of some position and posture associated with the second manipulator M2 and the position and the posture of the second control point T2, or may be information indicating relative positions and postures of some position and posture associated with another part of the robot 20 and the position and the posture of the second control point T2.

Second control point position information, which is information indicating the position of the second control point T2, and second control point posture information, which is information indicating the posture of the second control point T2, are associated with the second control point T2. Note that other information may be associated with the second control point T2 in addition to these kinds of information.

In this example, the position of the second control point T2 is represented by a position in the robot coordinate system RC of the origin of a second control point coordinate system TC2. The posture of the second control point T2 is represented by directions in the robot coordinate system RC of coordinate axes in the second control point coordinate system TC2. The second control point coordinate system TC2 is a three-dimensional local coordinate system associated with the second control point T2 to move together with the second control point T2.

When operating the robot 20 on the basis of the operation program stored in advance, the robot control device 30 specifies, as a position and a posture serving as targets for changing the position and the posture of the second control point T2, for example, the position indicated by the second control point position information designated by the operation program and the posture indicated by the second control point posture information designated by the operation program. In the following explanation, for convenience of explanation, as long as it is unnecessary to distinguish the position and the posture of the second control point T2, the position and the posture are collectively referred to as second arm position and explained. In the following explanation, as long as it is unnecessary to distinguish the position and the posture serving as the targets for changing the position and the posture of the second control point T2, the position and the posture are collectively referred to as second target position and explained. Note that the second arm position may be represented by only the position of the second control point T2. In this case, the second target position is represented by only the position serving as the target for changing the position of the second control point. The second arm position may be represented by another position and another posture based on the second arm or may be represented by only another position based on the second arm.

Second redundant degree of freedom information indicating a second redundant degree of freedom is designated to the robot control device 30 together with the second control point position information and the second control point posture information by the operation program stored in advance.

The second redundant degree of freedom refers to a redundant degree of freedom of the second arm that operates at a degree of freedom of seven axes. In this example, the second redundant degree of freedom refers to an angle of a second target plane with respect to a second reference plane.

The second target plane refers to a plane including a triangle formed by connecting the joint J22, the joint J24, and the joint J26 among the joints of the second arm to one another with straight lines when the second arm position coincides with a certain second target position. More specifically, for example, in this case, the second target plane is a plane including a triangle formed by connecting the position of the center of gravity of the joint J22, the position of the center of gravity of the joint J24, and the position of the center of gravity of the joint J26 to one another with straight lines. Note that, instead of this, in this case, the second target plane may be a plane including a triangle formed by connecting another position of the joint J22, another position of the joint J24, and another position of the joint J26 to one another with straight lines.

In this case, the second reference plane refers to a plane including a triangle formed by connecting the joint J22, the joint J24, and the joint J26 to one another with straight lines and refers to the plane in the case in which a turning angle of each of the joints J22 and J26 coincides with a second predetermined turning angle. More specifically, for example, in this case, the second reference plane refers to a plane including a triangle formed by connecting the position of the center of gravity of the joint J22, the position of the center of gravity of the joint J24, and the position of the center of gravity of the joint J26 and refers to the plane in the case in which the turning angle of each of the joints J22 and J26 coincides with the second predetermined turning angle.

The second predetermined turning angle may be any turning angle. In this example, the second predetermined turning angle of the joint J22 and the second predetermined turning angle of the joint J26 are the same turning angle. However, instead of this, the second predetermined turning angle of the joint J22 and the second predetermined turning angle of the joint J26 may be turning angles different from each other. Note that, instead of this, in this case, the second reference plane may be a plane including a triangle formed by connecting another position of the joint J22, another position of the joint J24, and another position of the joint J26 to one another with straight lines and may be the plane in the case in which the turning angle of each of the joints J22 and J26 coincides with the second predetermined turning angle.

The robot control device 30 specifies, as a second target redundant degree of freedom serving as a target for changing the second redundant degree of freedom of the second arm, the second redundant degree of freedom indicated by the second redundant degree of freedom information designated by the operation program.

The robot control device 30 calculates, according to inverse kinetics based on the second target position and the second target redundant degree of freedom specified in this way, turning angles in the case in which the second arm position coincides with the specified second target position and when the second redundant degree of freedom of the second arm coincides with the second target redundant degree of freedom, the turning angles being turning angles of the respective joints J21 to J27 included in the second arm. The robot control device 30 operates each of the joints J21 to J27, matches turning angles of the respective joints J21 to J27 with each of the calculated turning angles, and matches the second arm position with the second target position. In this example, the second arm posture, which is the posture of the second arm, is represented by a combination of the turning angles of the respective joints J21 to J27. That is, the robot control device 30 calculates, according to inverse kinetics based on the specified second target position and the specified second target redundant degree of freedom, a second arm posture in the case in which the second arm position coincides with the specified second target position and in the case in which the second redundant degree of freedom of the second arm coincides with the second target redundant degree of freedom. The robot control device 30 operates each of the joints J21 to J27, matches the present second arm posture with the calculated second arm posture, and matches the present second arm position with the calculated second target position. In this way, the robot control device 30 can operate the second arm on the basis of the operation program. Note that the second arm posture may be represented by another value based on the second arm.

When causing the operation program to designate the second redundant degree of freedom to the robot control device 30, for example, there is known a method of causing the operation program to designate the second redundant degree of freedom information indicating the second redundant degree of freedom for minimizing a load applied to the actuators included in the second arm when matching the second arm position with the second target position indicated by the second control point position information and the second control point posture information.

However, when the operation program is caused to designate the second redundant degree of freedom information to the robot control device 30 by such a method, the second arm posture of the second arm operated by the robot control device 30 sometimes does not coincide with the second arm posture desired by the user. For example, when the shape of the robot 20 is a shape corresponding to the shape of a person as shown in FIG. 1 (i.e., the shape of the robot 20 is a shape similar to the shape of the person), the second arm posture desired by the user among the second arm postures is the second arm posture corresponding to a posture that the person can take among the second arm postures. When the second arm posture desired by the user and the second arm posture do not coincide with each other, the user sometimes recalls, for example, a situation in which a deficiency occurs in the robot 20, a situation in which the robot 20 causes interference with another object, or a situation in which the robot 20 causes interference with the robot 20 itself. As a result, the user causes the robot 20 to perform work while feeling uneasiness.

In order to prevent the user from feeling uneasiness, the robot control device 30 in this example moves the second arm on the basis of second usability information in which usable second arm postures are determined among a plurality of second arm postures that the second arm can take when the second arm position coincides with the second target position serving as the target for changing the second arm position associated with the second arm including seven or more axes included in the robot 20. The robot control device 30 causes the robot 20 to perform the predetermined work. The second usability information is information in which possibility information indicating usability or unusability is associated with second arm posture information indicating each of one or more second arm postures. The second usability information is an example of usability information. The second arm posture is an example of an arm posture. The second arm posture information is an example of arm posture information. Consequently, the robot control device 30 can move the second arm while matching the second arm posture of the robot 20 with the second arm posture desired by the user.

In the following explanation, as an example, the second usability information is the same information as the first usability information. In this case, correspondence information for associating the first arm posture and the second arm posture is stored in advance in the robot control device 30. Consequently, the robot control device 30 can move the second arm on the basis of the first usability information. Note that the second usability information may be information different from the first usability information.

In the following explanation, processing in which the robot control device 30 causes the robot 20 to perform the predetermined work is explained. Processing in which the robot control device 30 controls the second arm in the processing is processing explained below and is processing same as the processing in which the robot control device 30 controls the first arm. Therefore, in the following explanation, explanation concerning the processing in which the robot control device 30 controls the second arm is omitted. In the robot system. 1, a role of the first arm and a role of the second arm may be reversed.

### Hardware Configuration of the Robot Control Device

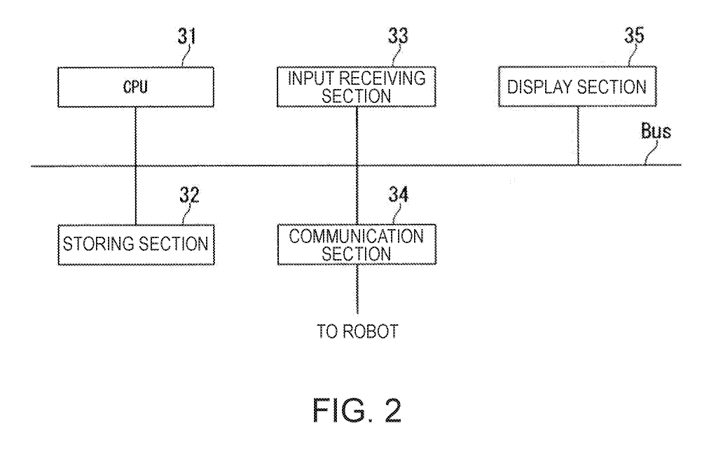

A hardware configuration of the robot control device 30 is explained below with reference to FIG. 2. FIG. 2 is a diagram showing an example of the hardware configuration of the robot control device 30.

The robot control device 30 includes, for example, a CPU (Central Processing Unit) 31, a storing section 32, an input receiving section 33, a communication section 34, and a display section 35. These components are communicably connected to one another via a bus Bus. The robot control device 30 performs communication with the robot 20 via the communication section 34.

The CPU 31 executes various computer programs stored in the storing section 32.

The storing section 32 includes, for example, an HDD (Hard Disk Drive), an SSD (Solid State Drive), an EEPROM (Electrically Erasable Programmable Read-Only memory), a ROM (Read-Only Memory), or a RAM (Random Access Memory). Note that, instead of the storing section 32 incorporated in the robot control device 30, the storing section 32 may be an external storage device connected by a digital input/output port or the like such as a USB. The storing section 32 stores various kinds of information processed by the robot control device 30, various computer programs including the operation programs, and various images.

The input receiving section 33 is, for example, a keyboard, a mouse, a touch pad, or another input device. Note that the input receiving section 33 may be a touch panel configured integrally with the display section 35.

The communication section 34 includes, for example, a digital input/output port such as a USB or an Ethernet (registered trademark) port.

The display section 35 is, for example, a liquid crystal display panel or an organic EL (Electro Luminescence) display panel.

### Functional Configuration of the Robot Control Device

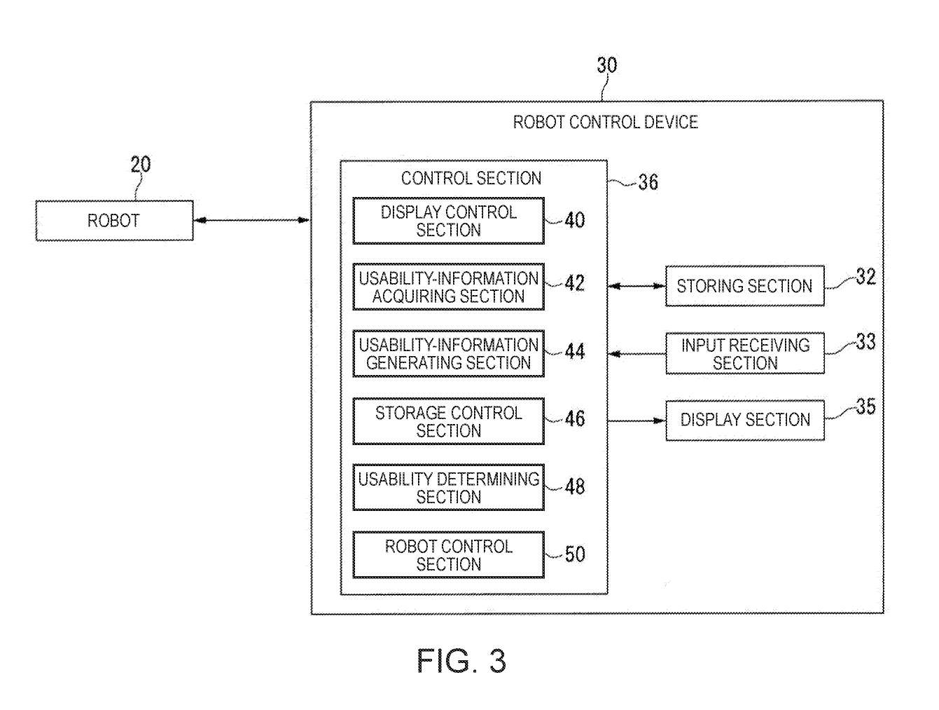

A functional configuration of the robot control device 30 is explained with reference to FIG. 3. FIG. 3 is a diagram showing an example of the functional configuration of the robot control device 30.

The robot control device 30 includes the storing section 32, the input receiving section 33, the display section 35, and a control section 36.

The control section 36 controls the entire robot control device 30. The control section 36 includes a display control section 40, a usability-information acquiring section 42, a usability-information generating section 44, a storage control section 46, a usability determining section 48, and a robot control section 50. These functional sections included in the control section 36 are realized by, for example, the CPU 31 executing various computer programs stored in the storing section 32. A part or all of the functional sections may be hardware functional sections such as an LSI (Large Scale Integration) and an ASIC (Application Specific Integrated Circuit).

The display control section 40 generates, on the basis of operation received from the user, various screens that the display control section 40 causes the display section 35 to display. The display control section 40 causes the display section 35 to display the generated screens.

The usability-information acquiring section 42 reads out, from the storing section 32, the first usability information stored in the storing section 32.

The usability-information generating section 44 generates first usability information.

The storing control section 46 causes the storing section 32 to store the first usability information generated by the usability-information generating section 44.

The usability determining section 48 determines whether the first arm posture indicated by the first arm posture information not included in the first usability information is the first arm posture desired by the user. When determining that the first arm posture is the first arm posture desired by the user, the usability determining section 48 determines that the first arm posture is a usable first arm posture. On the other hand, when determining that the first arm posture is not the first arm posture desired by the user, the usability determining section 48 determines that the first arm posture is an unusable first arm posture.

The robot control section 50 operates the robot 20. Processing in which the robot control device generates first usability information

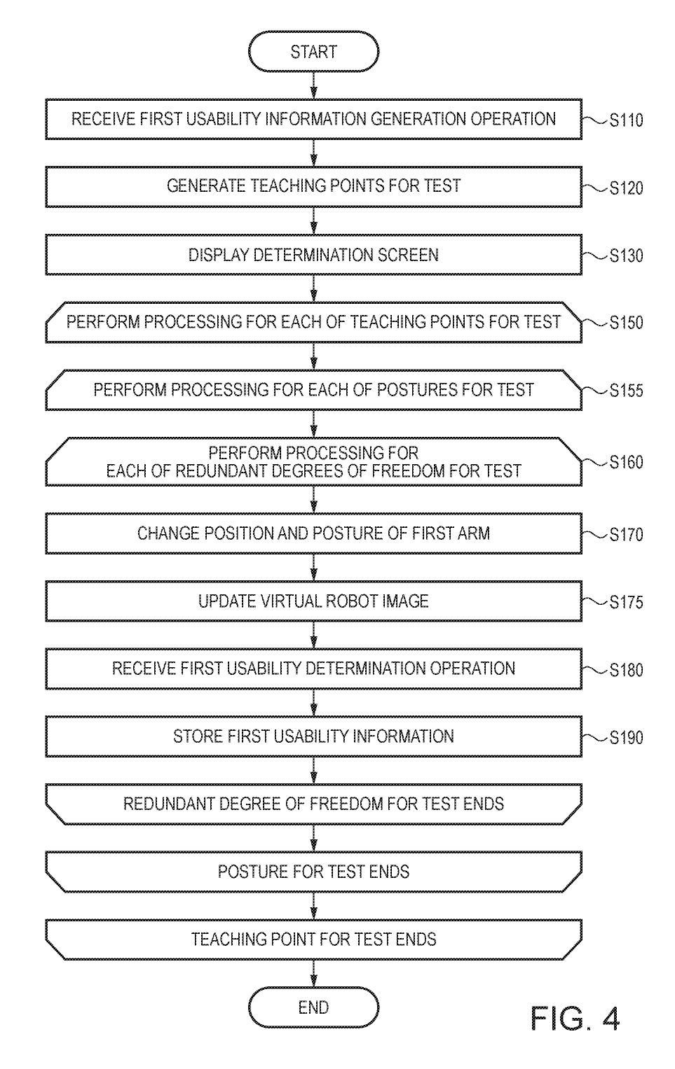

Processing in which the robot control device 30 generates first usability information is explained with reference to FIG. 4. FIG. 4 is a flowchart for explaining an example of a flow of the processing in which the robot control device 30 generates first usability information.

The robot control section 50 stays on standby until the robot control section 50 receives operation for generating the first usability information from the user. When receiving the operation from the user (step S110), the robot control section 50 generates teaching-point-for-test information indicating respective teaching points for test, which are one or more virtual points serving as targets for moving the first control point T1 when the robot control device 30 generates first usability information (step S120). The processing in step S120 is explained.

Teaching-point-for-test position information and teaching-point-for-test identification information are associated with the teaching points for test. The teaching-point-for-test position information is information indicating the positions of the teaching points for test. The teaching-point-for-test identification information is information for identifying the teaching points for test. In this example, the positions of the teaching points for test are represented by a position in the robot coordinate system RC of the origin of a teaching-point-for-test coordinate system, which is a three-dimensional local coordinate system associated with the teaching points for test. In this example, when a certain teaching point for test and the first control point T1 coincide with each other, the position of the first control point T1 coincides with the position of the teaching point for test.

In step S120, the robot control section 50 reads out, from the storing section 32, work region information indicating a work region stored in advance in the storing section 32. The work region is a region where the robot 20 is capable of performing work with the first arm and the second arm. Note that, instead of this, the work region may be a region where, when the robot 20 performs work only with either one of the first arm and the second arm, the robot 20 is capable of performing the work with the one arm. The robot control section 50 virtually divides, on the basis of the read-out work region information, the work region indicated by the work region information into rectangular parallelepiped partial regions having the same shape and the same size each other. The robot control section 50 specifies, for each of intersections of straight lines that virtually divide the work region, the intersections as the teaching points for test and associates, as the teaching-point-for-test position information, information indicating the positions of the intersections with the specified teaching points for test. The robot control section 50 generates teaching-point-for-test information indicating the respective specified teaching points for test. Note that the shapes and the sizes of a part or all of the partial regions may be shapes and sizes different from each other instead of the same shape and the same size.

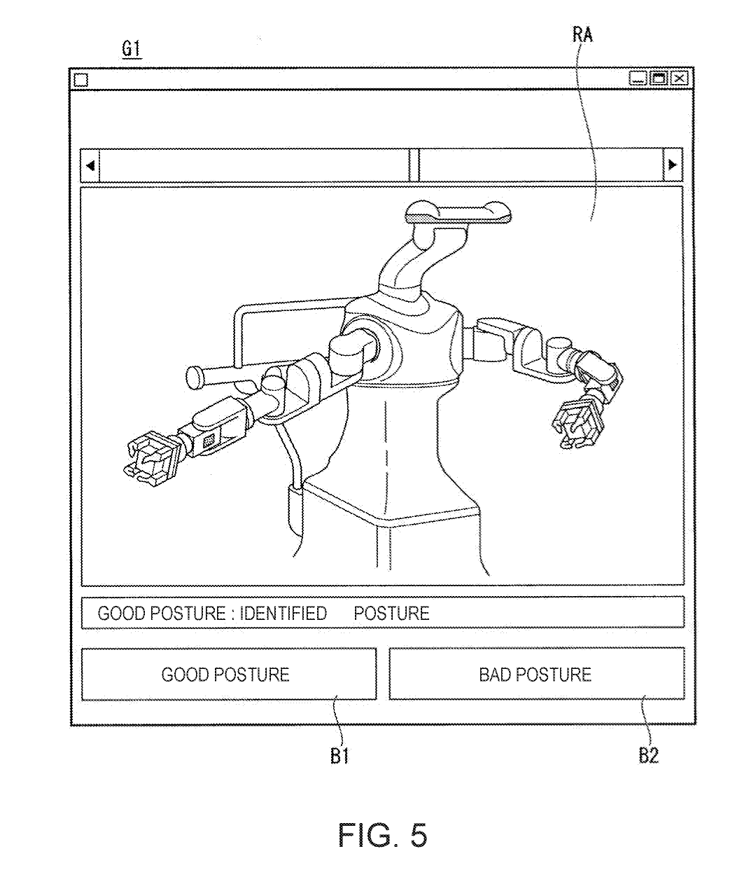

After the processing in step S120 is performed, the display control section 40 generates a determination screen, which is a screen for receiving, from the user, indication whether the first arm posture is the first arm posture desired by the user (i.e., whether the first arm posture is usable). The display control section 40 causes the display section 35 to display the generated determination screen (step S130). The processing in step S130 is explained with reference to FIG. 5.

FIG. 5 is a diagram showing an example of the determination screen. A determination screen G1 shown in FIG. 5 is an example of the determination screen that the display control section 40 causes the display section 35 to display. The determination screen G1 includes, for example, an image display region RA, a button B1, and a button B2. Note that the determination screen G1 may include other GUIs in addition to these GUIs (Graphical User Interfaces) or may include other GUIs instead of these GUIs.

The image display region RA is a region where a virtual robot image, which is an image representing a virtual robot 20 arranged by the display control section 40 in a virtual space in a storage region of the storing section 32, is displayed. In step S130, the display control section 40 generates a virtual space in the storage region of the storing section 32. The display control section 40 generates and arranges the virtual robot 20 in the generated virtual space. The display control section 40 acquires turning angles of the respective joints J11 to J17 and turning angles of the respective joints J21 to J27 from the actuators included in the robot 20. The display control section 40 matches the posture of the virtual robot 20 and the present posture of the real robot 20 with each other on the basis of the acquired turning angles. In this example, the posture of the robot 20 refers to the first arm posture and the second arm posture. The display control section 40 generates a virtual robot image representing the virtual robot 20 in the generated virtual space and causes the display section 35 to display the generated virtual robot image in the image display region RA. Note that, in this example, the virtual robot image is a three-dimensional image but may be a two-dimensional image instead of the three-dimensional image.

The button B1 is a button for deciding that the first arm posture in the posture of the virtual robot 20 represented by the virtual robot image displayed in the image display region RA is the first arm posture desired by the user. When the user performs selection operation (click, tap, etc.) on the button B1, the usability determining section 48 determines that the present first arm posture is the first arm posture desired by the user. As a result, the usability determining section 48 determines that the present first arm posture is usable.

The button B2 is a button for deciding that the first arm posture in the posture of the virtual robot 20 represented by the virtual robot image displayed in the image display region RA is not the first arm posture desired by the user. When the user performs selection operation (click, tap, etc.) on the button B2, the usability determining section 48 determines that the present first arm posture is not the first arm posture desired by the user. As a result, the usability determining section 48 determines that the present first arm posture is unusable.

After the processing in step S130 is performed, the robot control section 50 repeatedly performs processing in steps S155 to S190 for each of one or more teaching points for test indicated by the teaching-point-for-test information generated in step S120 (step S150).

After the teaching point for test is selected in step S150, the robot control section 50 reads out, from the storing section 32, posture information for test stored in advance in the storing section 32. The posture information for test is information indicating each of one or more postures for test. The posture for test is each of one or more postures selected by the user out of postures that the first control point T1 can take. The posture for test is represented by directions in the robot coordinate system RC of the coordinate axes in the first control point coordinate system TC1. The directions are represented by a coordinate of each of a U axis, a V axis, and a W axis in the robot coordinate system RC. The U axis is a coordinate axis representing a rotation angle in the case in which the first control point coordinate system TC1 is rotated around the X axis in the robot coordinate system RC. The V axis is a coordinate axis representing a rotation angle in the case in which the first control point coordinate system TC1 is rotated around the Y axis in the robot coordinate system RC. The W axis is a coordinate axis representing a rotation angle in the case in which the first control point coordinate system TC1 is rotated around a Z axis in the robot coordinate system RC.

The robot control section 50 repeatedly performs the processing in steps S160 to S190 for each of the one or more postures for test indicated by the posture information for test read out from the storing section 32 (step S155).

After the posture for test is selected instep S155, the robot control section 50 reads out, from the storing section 32, redundant-degree-of-freedom-for-test information stored in advance in the storing section 32. The redundant-degree-of-freedom-for-test information is information indicating each of one or more redundant degrees of freedom for test. The redundant degree of freedom for test is each of one or more turning angles selected by the user out of turning angles selectable as the first redundancy degree of freedom.

The robot control section 50 repeatedly performs the processing in steps S170 to S190 for each of the one or more redundant degrees of freedom for test indicated by the redundant-degree-of-freedom-for-test information read out from the storing section 32 (step S160).

The robot control section 50 matches the first redundant degree of freedom of the first arm with the redundant degree of freedom for test selected in step S160, matches the posture of the first control point T1 with the posture for test selected in step S155, and matches the position of the first control point T1 with the position of the teaching point for test selected in step S150 to thereby change the first arm position and the first arm posture (step S170). More specifically, the robot control section 50 designates, as the first redundant degree of freedom information, information indicating the redundant degree of freedom for test selected in step S160 to thereby match the first redundant degree of freedom with the redundant degree of freedom for test. The robot control section 50 designates, as the first control point posture information, information indicating the posture for test selected in step S155 and designates, as the first control point position information, information indicating the position of the teaching point for test selected in step S150 to thereby match the position of the first control point T1 with the position of the teaching point for test and match the posture of the first control point T1 with the posture for test.

The display control section 40 acquires turning angles of the respective joints J11 to J17 and turning angles of the respective joints J21 to J27 from the actuators included in the robot 20. The display control section 40 matches, on the basis of the acquired turning angles, the posture of the virtual robot 20 generated in step S130 with the present posture of the real robot 20. The display control section 40 generates a virtual robot image representing the virtual robot 20 and causes the display section 35 to display the generated virtual robot image in the image display region RA. When a virtual robot image is already displayed in the image display region RA, the display control section 40 causes the display section 35 to display the virtual robot image generated anew in the image display region RA again, that is, updates the virtual robot image displayed in the image display region RA (step S175).

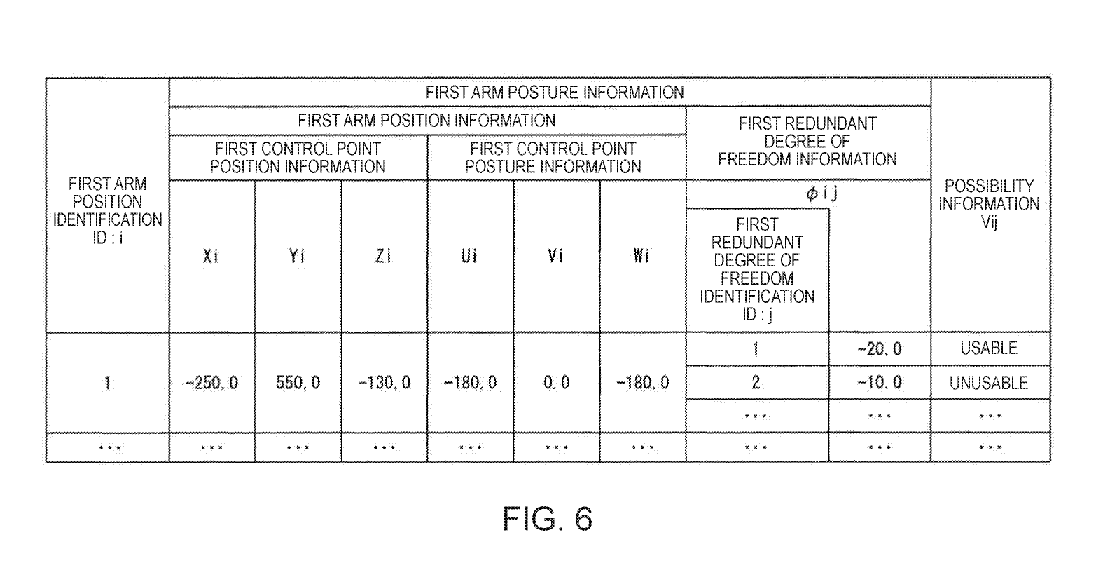

The usability determining section 48 stays on standby until selection operation (click or tap) is performed on the button B1 or the button B2 on the determination screen G1 displayed on the display section 35. When the selection operation is performed on either one of the button B1 and the button B2 (step S180), the usability determining section 48 generates possibility information associated with the present first arm posture. When the selection operation is performed on the button B1, the usability determining section 48 generates possibility information indicating usability as the possibility information associated with the present first arm posture. On the other hand, when the selection operation is performed on the button B2, the usability determining section 48 generates possibility information indicating unusability as the possibility information associated with the present first arm posture. After the usability determining section 48 generates the possibility information, the storage control section 46 generates first arm position information including currently designated first control point position information and currently designated first control point posture information. The storage control section 46 associates the generated first arm position information and a first arm position identification ID for identifying the first arm position information. The storage control section 46 generates first arm posture information in which the first arm position identification ID, the first arm position information, and currently designated first redundant degree of freedom information associated with a first redundant degree of freedom identification ID for identifying the first redundant degree of freedom information are associated. The storage control section 46 stores the generated first arm posture information and the generated possibility information in the first usability information stored in the storing section 32 in association with each other (step S190). The first usability information is explained with reference to FIG. 6.

FIG. 6 is a diagram showing an example of the first usability information stored in the storing section 32. As shown in FIG. 6, the first usability information is a table that stores information in which i (i is an integer equal to or larger than 1), which is the first arm position identification ID, first arm posture information associated with the i, and possibility information associated with the first arm posture information are associated. The first arm posture information includes the first arm position information associated with the i. The first arm position information includes first control point position information and first control point posture information associated with the i. First redundant degree of freedom information associated with the i is associated with j (j is an integer equal to or larger than 1), which is a first redundant degree of freedom identification ID of the first redundant degree of freedom information.

In the example shown in FIG. 6, first control point position information in the case in which the first arm position identification ID is i is three coordinates indicating the position of the first control point T1. The three coordinates refer to an X coordinate Xᵢ indicating the position of the first control point T1, which is a position in an X-axis direction in the robot coordinate system RC, a Y coordinate Yᵢ indicating the position of the first control point T1, which is a position in a Y-axis direction in the robot coordinate system RC, and a Z coordinate Zᵢ indicating the position of the first control point T1, which is a position in a Z-axis direction in the robot coordinate system RC.

In the example shown in FIG. 6, first control point posture information in the case in which the first arm position identification ID is i is three coordinates indicating the posture of the first control point T1. The three coordinates refer to a U coordinate Uᵢ indicating the posture of the first control point T1, which is a posture in a U-axis direction in the robot coordinate system RC, a V coordinate Vᵢ indicating the posture of the first control point T1, which is a posture in a V-axis direction in the robot coordinate system RC, and a W coordinate Wᵢ indicating the posture of the first control point T1, which is a posture in a W-axis direction in the robot coordinate system RC.

Information indicating a first redundant degree of freedom in the case in which the first arm position identification ID is i and in the case in which the first redundant degree of freedom identification ID is j refers to a turning angle φᵢⱼ. Possibility information in the case in which the first arm position identification ID is i and in the case in which the first redundant degree of freedom Vᵢⱼ. identification ID is j refers to possibility information V.

Specifically, first arm posture information in the case in which i, which is the first arm position identification ID, is 1 and in the case in which j, which is the first redundant degree of freedom identification ID, is 1 in the example shown in FIG. 6 includes an X coordinate X₁=−250.0, a Y coordinate Y₁=550.0, a Z coordinate Z₁=−150.0, a U coordinate U₁=−180.0, a V coordinate V₁=0.0, a W coordinate W₁=−180.0, and a turning angle φ₁₁=−20.0. Possibility information V₁₁ in this case indicates usability. Note that the possibility information Vᵢⱼ may indicate usability or unusability using a flag or 1 or 0.

Note that the first usability information may be, instead of the table shown in FIG. 6, other information that stores information in which the first arm posture information, the possibility information, and the first arm position identification ID are associated. When first usability information is not generated in the storing section 32, the storage control section 46 generates first usability information in the storing section 32 and stores, in the generated first usability information, information in which the first arm posture information, the possibility information, and the first arm position identification ID are associated.

The robot control device 30 repeatedly performs the processing in steps S150 to S190 to thereby store, in the first usability information, information in which the first arm posture information, the first arm position identification ID, and the possibility information for each combination of one or more teaching points for test, one or more postures for test, and one or more redundant degrees of freedom for test are associated. Consequently, the robot control device 30 can execute processing explained below, that is, processing in which the robot control device 30 causes the robot 20 to perform the predetermined work.

Specific Example 1 of the Processing in which the Robot Control Device Causes the Robot to Perform the Predetermined Work

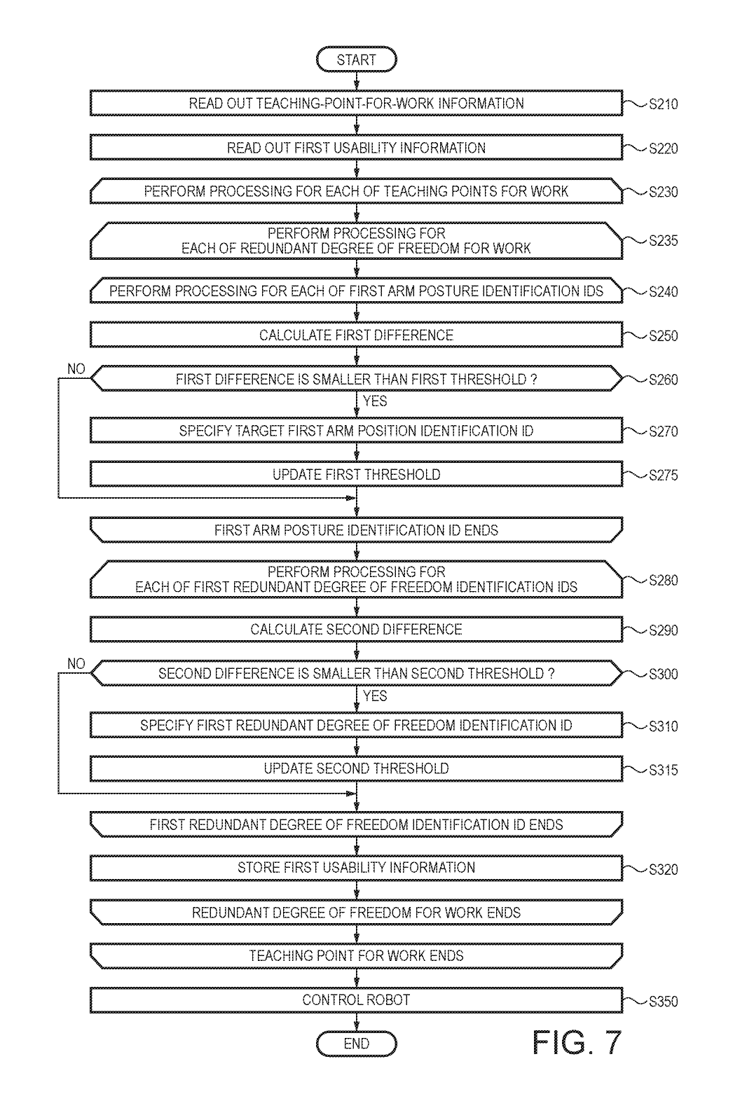

A specific example 1 of the processing in which the robot control device 30 causes the robot 20 to perform the predetermined work is explained below with reference to FIG. 7. FIG. 7 is a flowchart for explaining a flow of the specific example 1 of the processing in which the robot control device 30 causes the robot 20 to perform the predetermined work.

The robot control section 50 reads out, from the storing section 32, teaching-point-for-work information stored in advance in the storing section 32 (step S210). The teaching-point-for-work information is information indicating each of one or more teaching points for work. The teaching points for work are one or more virtual points serving as targets for moving the first control point T1 when the robot control device 30 causes the robot 20 to perform the predetermined work. Teaching-point-for-work position information, teaching-point-for-work posture information, and teaching-point-for-work identification information are associated with the teaching points for work. The teaching-point-for-work position information is information indicating the positions of the teaching points for work. The teaching-point-for-work posture information is information indicating the postures of the teaching points for work. The teaching-point-for-work identification information is information for identifying the teaching points for work. In this example, the positions of the teaching points for work are represented by a position in the robot coordinate system RC of the origin of a teaching-point-for-work coordinate system, which is a three-dimensional local coordinate system associated with the teaching points for work. Postures of the teaching points for work are represented by directions in the robot coordinate system RC of coordinate axes in the teaching-point-for-work coordinate system. In this example, when a certain teaching point for work and the first control point T1 coincide with each other, the position and the posture (i.e., the first arm position) of the first control point T1 coincide with the position and the posture of the teaching point for work.

The teaching-point-for-work information is stored in advance in the storing section 32 of the robot control device 30 by online teaching, direct teaching, or the like performed by the user using the teaching device. In the robot control device 30, when the teaching points for work are designated one by one by the operation program, information indicating the positions of the designated teaching points for work are designated as first teaching point position information. Information indicating the postures of the designated teaching points for work are designated as first teaching point posture information.

After the processing in step S210 is performed, the usability-information acquiring section 42 reads out, from the storing section 32, first usability information stored in advance in the storing section 32 (step S220). Subsequently, the usability-information generating section 44 repeatedly performs processing in steps S235 to S320 for each of the one or more teaching points for work indicated by the teaching-point-for-work information read out in step S210 (step S230).

After the teaching point for work is selected in step S230, the usability-information generating section 44 reads out, from the storing section 32, redundant-degree-of-freedom-for-work information stored in advance in the storing section 32. The redundant-degree-of-freedom-for-work information is information indicating each of one or more redundant degrees of freedom for work. The redundant degree of freedom for work is each of one or more turning angles selected by the user out of turning angles selectable as a first redundant degree of freedom when causing the robot 20 to perform the predetermined work. The redundant degree of freedom for work may be the same as the redundant degree of freedom for test or may be different from the redundant degree of freedom for test.

The usability-information generating section 44 repeatedly performs the processing in steps S240 to S320 for each of the one or more redundant degrees of freedom for work indicated by the redundant-degree-of-freedom-for-work information read out from the storing section 32 (step S235).

The usability-information generating section 44 selects, one by one, first arm position identification IDs included in the first usability information read out in step S220 and repeatedly performs the processing in steps S250 to S275 for each of the selected first arm position identification IDs (step S240).

The usability-information generating section 44 calculates a first difference, which is a difference between a position and a posture indicated by first control point position information and first control point posture information included in first arm position information indicated by the first arm position identification ID read out in step S240 among pieces of first arm posture information included in the first usability information and a position and a posture of the teaching point for work selected in step S230 (step S250). The position and the posture indicated by the first control point position information and the first control point posture information refer to the position indicated by the first control point position information and the posture indicated by the first control point posture information. The processing in step S250 is explained.

The usability-information generating section 44 calculates, as a first difference, a norm of a differential vector between a first arm position vector based on the position and the posture indicated by the first control point position information and the first control point posture information included in the first arm position information indicated by the first arm position identification ID read out in step S240 and a teaching-point-for-work position/posture vector based on the position and the posture of the teaching point for work selected in step S230. The first arm position vector is a vector having, as a component, each of three coordinates (i.e., the X coordinate Xᵢ, the Y coordinate Yᵢ, and the Z coordinate Zᵢ) representing the position indicated by the first control point position information and three coordinates (i.e., the U coordinate Uᵢ, the V coordinate Vᵢ, and the W coordinate Wᵢ) representing the posture indicated by the first control point posture information and having the coordinates in the order of the X coordinate Xᵢ, the Y coordinate Yᵢ, the Z coordinate Zᵢ, the U coordinate Uᵢ, the V coordinate Vᵢ, and the W coordinate Wᵢ. The teaching-point-for-work position/posture vector is a vector having, as a component, each of an X coordinate, a Y coordinate, a Z coordinate, a U coordinate, a V coordinate, and a W coordinate indicating the position and the posture of the teaching point for work and having the coordinates in the order of the X coordinate, the Y coordinate, the Z coordinate, the U coordinate, the V coordinate, and the W coordinate. Note that, instead of the norm of the differential vector between the first arm position vector and the teaching-point-for-work position/posture vector, the first difference may be calculated by the usability-information generating section 44 as another value based on each of the three coordinates representing the position indicated by the first control point position information and the three coordinates representing the posture indicated by the first control point posture information and each of the X coordinate, the Y coordinate, the Z coordinate, the U coordinate, the V coordinate, and the W coordinate indicating the position and the posture of the teaching point for work.

After the processing in step S250 is performed, the usability-information generating section 44 determines whether the first difference calculated in step S250 is smaller than a predetermined first threshold (step S260). When step S260 is executed first, in this example, the usability-information generating section 44 uses, as the first threshold, a value equal to or larger than a largest value obtained as the first difference. The largest value can be geometrically calculated from the shape and the size of a partial region having a largest size among the partial regions divided from the work region in the processing in step S120 shown in FIG. 4. Note that, instead of this, the first threshold in the first execution of step S260 may be another value. However, the first threshold should not be a value equal to or smaller than a smallest value obtained as the first difference.

When determining that the first difference is equal to or larger than the predetermined first threshold (NO in step S260), the usability-information generating section 44 shifts to step S240 and selects the next first arm position identification ID. However, when an unselected first arm position identification ID is absent in step S240, the usability-information generating section 44 shifts to step S280. On the other hand, when determining that the first difference is smaller than the predetermined first threshold (YES in step S260), the usability-information generating section 44 specifies, as a target first arm position identification ID, the first arm position identification ID selected in step S240 (step S270). When the target first arm position identification ID is already specified, the usability-information generating section 44 updates the target first arm position identification ID and specifies the first arm position identification ID as a new target first arm position identification ID again.

Subsequently, the usability-information generating section 44 updates the first threshold to the first difference calculated in step S250 (step S275). Consequently, the first threshold used by the usability-information generating section 44 in executing step S260 next time is changed to the first difference. The usability-information generating section 44 shifts to step S240 and selects the next first arm position identification ID. However, when an unselected first arm position identification ID is absent in step S240, the usability-information generating section 44 shifts to step S280.

By repeatedly performing the processing in steps S240 to S275 in this way, the usability-information generating section 44 can specify a first arm position identification ID of first arm position information including first control point position information and first control point posture information indicating a first arm position closest to (having a smallest difference from) the first arm position in the case in which the teaching point for work selected in step S230 and the first control point T1 coincide with each other. The first arm position information refers to first arm position information included in the first usability information read out in step S220.

After the repeated processing in steps S240 to S275 is performed, the usability-information generating section 44 repeatedly performs the processing in steps S290 to S315 for each of non-overlapping first redundant degree of freedom identification IDs among first redundant degree of freedom identification IDs included in the first usability information read out in step S220 (step S280).

The usability-information generating section 44 calculates, as a second difference, a root square of a difference between the redundant degree of freedom for work selected in step S235 and a first redundant degree of freedom indicated by the first redundant degree of freedom identification ID selected in step S280 (step S290).

Subsequently, the usability-information generating section 44 determines whether the second difference calculated in step S290 is smaller than a predetermined second threshold (step S300). When step S300 is executed first, in this example, the usability-information generating section 44 uses 360° as the second threshold. Note that, instead of this, the second threshold in the first execution of step S300 may be another value. However, in processing explained below, the second threshold is desirably a value close to 360° in order to specify a first redundant degree of freedom identification ID indicating a first redundant degree of freedom closest to (having a smallest difference from) the redundant degree of freedom for work selected in step S235.

When determining that the second difference is equal to or larger than the predetermined second threshold (NO in step S300), the usability-information generating section 44 shifts to step S280 and selects the next first redundant degree of freedom identification ID. However, when an unselected first redundant degree of freedom identification ID is absent in step S280, the usability-information generating section 44 shifts to step S320. On the other hand, when determining that the second difference is smaller than the second threshold (YES in step S300), the usability-information generating section 44 specifies, as a target first redundant degree of freedom identification ID, the first redundant degree of freedom identification ID selected in step S280 (step S310). When a target first redundant degree of freedom identification ID is already specified, the usability-information generating section 44 updates the target first redundant degree of freedom identification ID and specifies the first redundant degree of freedom identification ID as a new target first redundant degree of freedom identification ID again.

Subsequently, the usability-information generating section 44 updates the second threshold to the second difference calculated in step S290 (step S315). Consequently, the second threshold used by the usability-information generating section 44 in executing step S300 next time is changed to the second difference. The usability-information generating section 44 shifts to step S280 and selects the next first redundant degree of freedom identification ID. However, when an unselected first redundant degree of freedom identification ID is absent in step S280, the usability-information generating section 44 shifts to step S320.

By repeatedly performing the processing in steps S280 to S315 in this way, the usability-information generating section 44 can specify a first redundant degree of freedom identification ID indicating a first redundant degree of freedom closest to (having a smallest difference from) the redundant degree of freedom for work selected in step S235. The first redundant degree of freedom. identification ID refers to a first redundant degree of freedom identification ID selectable in step S280.

After the repeated processing in step S280 to S315 is performed, the usability-information generating section 44 specifies, out of the first usability information read out in step S220, possibility information associated with first arm posture information including both of the target first arm position identification ID specified in step S270 and the target first redundant degree of freedom identification ID specified in step S310. The usability-information generating section 44 generates, on the basis of the specified possibility information, first arm posture information indicating a first arm posture in the case in which the teaching point for work selected in step S230 and the first control point T1 coincide with each other and in the case in which the redundant degree of freedom for work selected in step S235 and the first redundant degree of freedom of the first arm coincide with each other. The usability-information generating section 44 stores, in the first usability information, information in which the specified possibility information and a first arm position identification ID for identifying arm position information included in the generated first arm posture information are associated with the generated first arm posture information (step S320). The first arm position identification ID is an ID not overlapping another first arm position identification ID in the first usability information.

By repeating the processing in steps S230 to S320 in this way, the robot control device 30 can generate first usability information including information indicating usability of a first arm posture that can be taken when the first control point T1 coincides with each of the one or more teaching points for work indicated by the teaching point information for work read out in step S210 (i.e., the information stored in the first usability information in step S320). Consequently, when causing the robot 20 to perform the predetermined work, the robot control device 30 can cause, on the basis of the first usability information, the robot 20 to perform the predetermined work while causing the first arm to take a first arm posture desired by the user.

After the repeated processing in steps S230 to S320 is performed, the robot control section 50 causes the robot 20 to perform the predetermined work on the basis of the operation program stored in advance in the storing section 32 and the teaching-point-for-work information and the first usability information stored in the storing section 32 (step S350) and ends the processing. Specifically, in step S350, the robot control device 30 selects, one by one, the one or more teaching points for work indicated by the teaching-point-for-work information according to the operation program, designates information indicating the positions of the selected teaching points for work as first control point position information, and designates information indicating the postures of the teaching points for work as first control point posture information. The robot control device 30 specifies, among pieces of first position information included in the first usability information, first arm position information including the designated first control point position information and the designated first control point posture information. The robot control device 30 specifies, among pieces of first redundant degree of freedom information associated with the specified first arm position information, first redundant degree of freedom information associated with the possibility information indicating usability. The robot control device 30 selects first redundant degree of freedom information satisfying a predetermined matching condition from the specified first redundant degree of freedom information. The matching condition is satisfaction of any one of three conditions described below.

Condition 1) Selectable first redundant degree of freedom information is only one piece of information

Condition 2) A value obtained by adding up rotation change amounts of the joints included in the first arm is minimized when the first arm is operated

Condition 3) A load applied to the actuators included in the first arm is minimized when the first arm is operated

Note that the matching condition may be another condition. For example, the robot control device 30 may select one piece of first redundant degree of freedom information at random from specified pieces of first redundant degree of freedom information.

The robot control device 30 calculates, according to inverse kinetics based on a first redundant degree of freedom indicated by the selected first redundant degree of freedom information, a position indicated by the designated first control point position information, and a posture indicated by the designated first control point posture information, turning angles in the case in which a first arm position coincides with a first target position, which is the position and the posture, and the case in which the first redundant degree of freedom of the first arm coincides with a first target redundant degree of freedom, which is the first redundant degree of freedom, the turning angles being turning angles of the respective joints J11 to J17 of the first arm. The robot control device 30 operates each of the joints J11 to J17, matches the turning angles of the respective joints J11 to J17 with the calculated turning angles, and matches the first arm position with the first target position. Consequently, the robot control device 30 can move the first arm while matching a first arm posture of the robot 20 with a first arm posture desired by the user.

Specific Example 2 of the Processing in which the Robot Control Device Causes the Robot to Perform the Predetermined Work

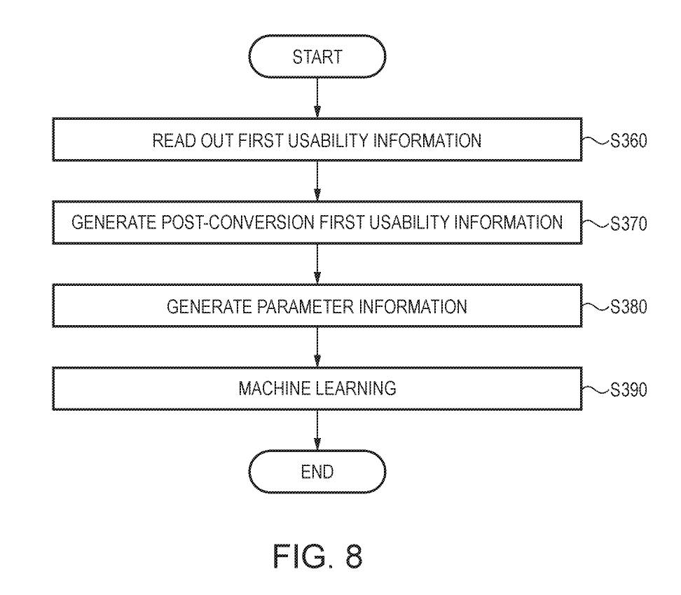

A specific example 2 of the processing in which the robot control device 30 causes the robot 20 to perform the predetermined work is explained with reference to FIGS. 8 to 12.

In the specific example 2 of the processing in which the robot control device 30 causes the robot 20 to perform the predetermined work, the robot control device 30 performs machine learning of a target correspondence relation, which is a correspondence relation between each of one or more pieces of first arm posture information included in the first usability information generated by the processing of the flowchart shown in FIG. 4 and usability or unusability indicated by possibility information associated with each of the pieces of first arm posture information. In this example, the robot control device 30 performs the machine learning using a method of supervised machine learning. More specifically, the robot control device 30 uses the support vector machine as the method. The robot control device 30 determines, on the basis of the target correspondence relation on which the machine learning is performed, which of possibility information indicating usability and possibility information indicating unusability is likely as possibility information associated with first arm posture information not included in first usability information. The robot control device 30 stores, on the basis of a result of the determination, in the first usability information, information in which the first arm posture information and the possibility information determined as likely as the possibility information associated with the first arm posture information are associated. Consequently, the robot control device 30 can cause, on the basis of the first usability information, the robot 20 to perform the predetermined work while matching a first arm posture with a first arm posture desired by the user. Note that, since the support vector machine is a publicly-known technique, detailed explanation is omitted concerning the support vector machine. As a method of performing the machine learning of the target correspondence relation, another method may be used instead of the method of the supervised machine learning such as the support vector machine. As the method of the supervised machine learning, another method may be used instead of the support vector machine.

FIG. 8 is a flowchart for explaining an example of a flow of processing by the robot control device 30 that performs the machine learning of the target correspondence relation.

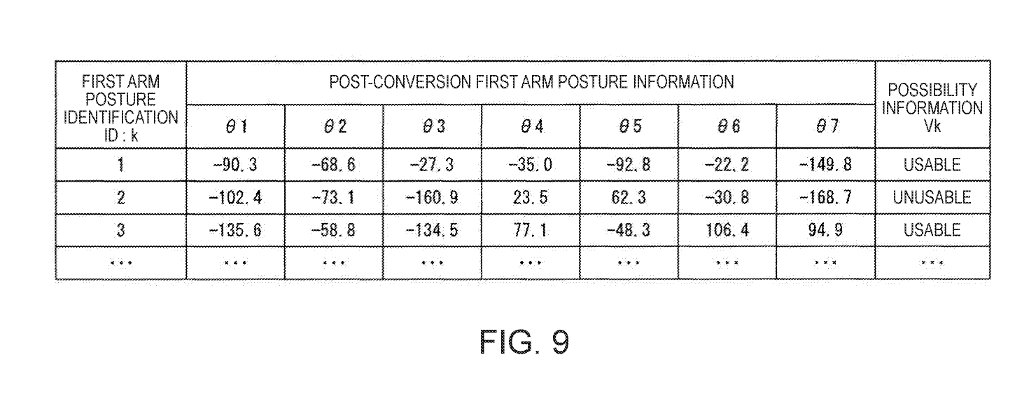

The usability determining section 48 reads out, from the storing section 32, first usability information stored in advance in the storing section 32 (step S360). The first usability information is first usability information that the robot control device 30 causes the storing section 32 to store according to the processing of the flowchart shown in FIG. 4. Subsequently, the usability determining section 48 generates post-conversion first usability information, which is first usability information obtained by converting each of pieces of first arm posture information included in the first usability information read out instep S360 into turning angle information (step S370). The processing in step S370 is explained with reference to FIG. 9.

FIG. 9 is a diagram showing an example of the post-conversion first usability information. In the example shown in FIG. 9, the post-conversion first usability information is a table in which k, which is a first arm posture identification ID for identifying each of combinations of i, which is the first arm position identification ID, and j, which is the first redundant degree of freedom identification ID, shown in FIGS. 6, θ₁ to θ₇, which are post-conversion first arm posture information, and possibility information Vₖ associated with the k are stored in association with one another. θ₁ is a turning angle of the joint J11, θ₂ is a turning angle of the joint J12, θ₃ is a turning angle of the joint J13, θ₄ is a turning angle of the joint J14, θ₅ is a turning angle of the joint J15, θ₆ is a turning angle of the joint J16, and θ₇ is a turning angle of the joint J17.

For example, a record in which k, which is the first arm posture identification ID, is 1 among records included in the table shown in FIG. 9 corresponds to a record in which i, which is the first arm position identification ID, is 1 and j, which is the first redundant degree of freedom identification ID, is 1. That is, θ₁ to θ₇ included in the record in which k, which is the first arm posture identification ID, is 1 among the records included in the table shown in FIG. 9 are turning angles of the respective joints J11 to J17 calculated by inverse kinetics based on first arm posture information and first redundant degree of freedom information included in the record in which i, which is the first arm position identification ID, is 1 and j, which is the first redundant degree of freedom identification ID, is 1 among the records included in the table shown in FIG. 6.

For example, a record in which k, which is the first arm posture identification ID, is 2 among the records included in the table shown in FIG. 9 corresponds to a record in which i, which is the first arm position identification ID, is 1 and j, which is the first redundant degree of freedom identification ID, is 2 among the records included in the table shown in FIG. 6. That is, θ₁ to θ₇ included in the record in which k, which is the first arm posture identification ID, is 2 among the records included in the table shown in FIG. 9 are turning angles of the respective joints J11 to J17 calculated by inverse kinetics based on first arm posture information and first redundant degree of freedom information included in the record in which i, which is the first arm position identification ID, is 1 and j, which is the first redundant degree of freedom identification ID, is 2 among the records included in the table shown in FIG. 6.

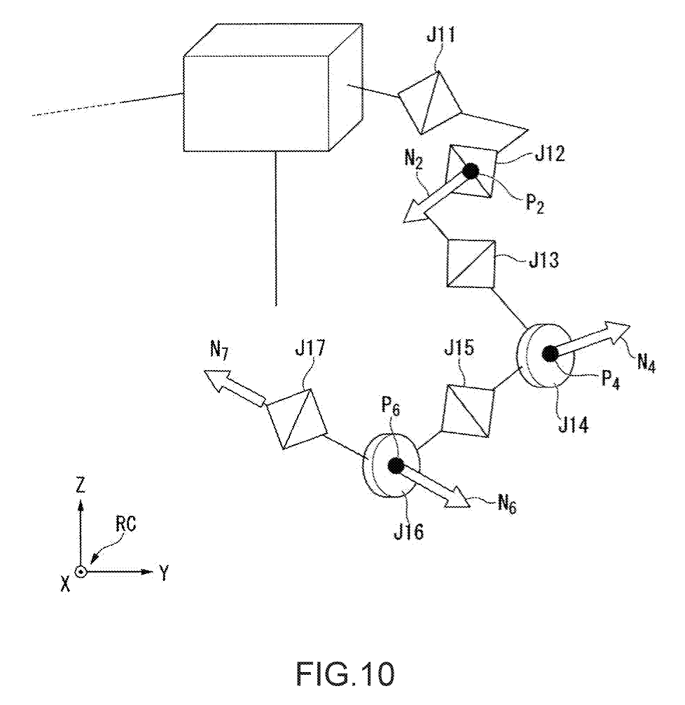

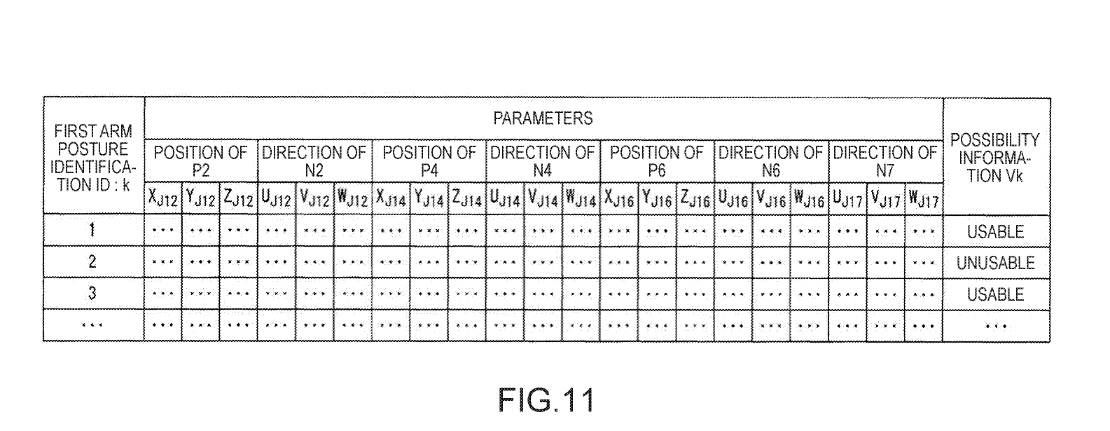

After the processing in step S370 is performed, the usability determining section 48 generates parameter information, which is post-conversion first usability information obtained by converting the post-conversion first arm posture information included in the post-conversion first usability information generated in step S370 into one or more parameters representing a first arm posture indicated by the post-conversion first arm posture information (step S380). In the following explanation, as an example, in step S380, the robot control device 30 generates parameter information, which is post-conversion first usability information obtained by converting the post-conversion first arm posture information included in the post-conversion first usability information generated in step S370 into six kinds of parameters representing a first arm posture indicated by the post-conversion first arm posture information. The six kinds of parameters are a part of parameters (i.e., the target correspondence relation) learned by the support vector machine. The processing in step S370 is explained with reference to FIGS. 10 to 11.

The usability determining section 48 reads out, from the storing section 32, first arm information indicating the shapes, the sizes, and the like of members configuring the first arm stored in advance in the storing section 32. The usability determining section 48 calculates, on the basis of the read-out first arm information and the post-conversion first arm posture information included in the post-conversion first usability information generated in step S370, parameters in the first arm posture indicated by the post-conversion first arm posture information, that is, seven kinds of parameters described below.

The position of the joint J12

The posture of the joint J12

The position of the joint J14

The posture of the joint J14

The position of the joint J16

The posture of the joint J16

The posture of the joint J17

The position of the joint J12 is three coordinates representing a position in the robot coordinate system RC of the origin of a joint coordinate system JT12, which is a three-dimensional local coordinate system associated with the center of gravity of the joint J12 (an X coordinate X_{J12}, a Y coordinate Y_{J12}, and a Z coordinate Z_{J12} representing the position in the robot coordinate system RC). In this example, the origin coincides with the center of gravity. Note that the origin may not coincide with the center of gravity.

The posture of the joint J12 is three coordinates representing a direction in the robot coordinate system. RC of a Z axis in the joint coordinate system JT12 (a U coordinate U_{J12}, a V coordinate V_{J-12}, and a W coordinate W_{J12} representing the direction in the robot coordinate system RC). In this example, the direction of the Z axis coincides with a direction on the joint J13 side of directions extending along a turning shaft of the joint J12. Note that the direction of the Z axis may not coincide with the direction on the joint J13 side of the directions extending along the turning shaft of the joint J12.

The position of the joint J14 is three coordinates representing a position in the robot coordinate system RC of the origin of a joint coordinate system JT14, which is a three-dimensional local coordinate system associated with the center of gravity of the joint J14 (an X coordinate X_{J14}, a Y coordinate Y_{J14}, and a Z coordinate Z_{J14} representing the position in the robot coordinate system RC). In this example, the origin coincides with the center of gravity. Note that the origin may not coincide with the center of gravity. In this example, the direction of the Z axis coincides with either one of directions extending along a turning shaft of the joint J14. Note that the direction of the Z axis may coincide with none of the directions extending along the turning shaft of the joint J14.

The posture of the joint J14 is three coordinates representing a direction in the robot coordinate system. RC of the Z axis in the joint coordinate system JT14 (a U coordinate U_{J14}, a V coordinate V_{J14}, and a W coordinate W_{J14} representing the direction in the robot coordinate system RC). In this example, the direction of the Z axis coincides with either one of directions extending along a turning shaft of the joint J14. Note that the direction of the Z axis may coincide with none of the directions extending along the turning shaft of the joint J14.

The position of the joint J16 is three coordinates representing a position in the robot coordinate system RC of the origin of a joint coordinate system JT16, which is a three-dimensional local coordinate system associated with the center of gravity of the joint J16 (an X coordinate X_{J16}, a Y coordinate Y_{J16}, and a Z coordinate Z_{J16} representing the position in the robot coordinate system RC). In this example, the origin coincides with the center of gravity. Note that the origin may not coincide with the center of gravity.

The posture of the joint J16 is three coordinates representing a direction in the robot coordinate system. RC of the Z axis in the joint coordinate system JT16 (a U coordinate U_{J16}, a V coordinate V_{J16}, and a W coordinate W_{J16} representing the direction in the robot coordinate system RC). In this example, the direction of the Z axis coincides with either one of directions extending along a turning shaft of the joint J16. Note that the direction of the Z axis may coincide with none of the directions extending along the turning shaft of the joint J16.

The posture of the joint J17 is three coordinates representing a direction in the robot coordinate system. RC of the Z axis in a joint coordinate system JT17, which is a three-dimensional local coordinate system associated with the center of gravity of the joint J17 (a U coordinate U_{J17}, a V coordinate V_{J17}, and a W coordinate W_{J17} representing the direction in the robot coordinate system RC). In this example, the direction of the Z axis coincides with a direction on the first end effector E1 side of directions extending along a turning shaft of the joint J17. In this example, the origin of the joint coordinate system JT17 coincides with the center of gravity. Note that the origin may not coincide with the center of gravity. The direction of the Z axis may not coincide with the direction on the first end effector E1 side of the directions extending along the turning shaft of the joint J17.

FIG. 10 is a diagram showing an example of a logical structure of the first arm. A point P2 shown in FIG. 10 represents a position in the robot coordinate system RC of the origin of the joint coordinate system JT12. An arrow N2 represents a direction in the robot coordinate system RC of the Z axis in the joint coordinate system JT12. A point P4 represents a position in the robot coordinate system RC of the origin of the joint coordinate system JT14. An arrow N4 represents a direction in the robot coordinate system RC of the Z axis in the joint coordinate system JT14. A point P6 represents a position in the robot coordinate system RC of the origin of the joint coordinate system JT16. An arrow N6 represents a direction in the robot coordinate system RC of the Z axis in the joint coordinate system JT16. An arrow N7 represents a direction in the robot coordinate system RC of the Z axis in the joint coordinate system JT17. Apart or all of the seven kinds of parameters may be other parameters representing the first arm posture indicated by the post-conversion first arm posture information.

The usability determining section 48 generates, on the basis of the first arm information read out from the storing section 32 and the post-conversion first arm posture information included in the post-conversion first usability information generated in step S370, parameter information, which is post-conversion first usability information converted into the seven kinds of parameters representing the first arm posture indicated by the post-conversion first arm posture information. FIG. 11 is a diagram showing an example of the parameter information.

For example, a record in which k, which is the first arm posture identification ID, is 1 among records included in a table shown in FIG. 11 corresponds to the record in which k, which is the first arm posture identification ID, is 1 among the records included in the table shown in FIG. 9. That is, each of seven kinds of parameters included in the record in which k, which is the first arm posture identification ID, is 1 among the records included in the table shown in FIG. 11 is a parameter obtained by the robot control device 30 converting the post-conversion first arm posture information included in the record in which k, which is the first arm posture identification ID, is 1 among the records included in the table shown in FIG. 9.

After the processing in step S380 is performed, the usability determining section 48 causes the support vector machine stored in advance in the storing section 32 to learn, as a target correspondence relation, each of combinations of the parameters and the possibility information associated with each of first arm posture identification IDs included in the parameter information generated in step S380 (step S390) and ends the processing.

The robot control device 30 causes the support vector machine to learn the target correspondence relation in this way. The robot control device 30 causes the robot 20 to perform the predetermined work using the support vector machine that has learned the target correspondence relation.

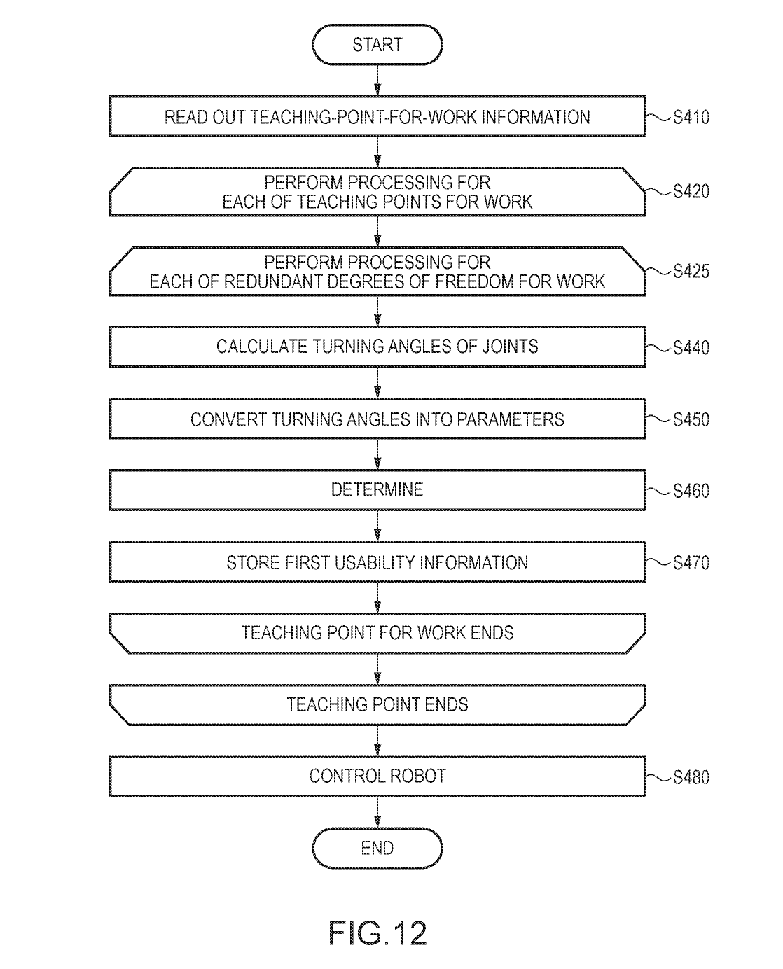

FIG. 12 is a flowchart for explaining another example of the flow of the processing in which the robot control device 30 causes the robot 20 to perform the predetermined work.

The robot control section 50 reads out, from the storing section 32, teaching-point-for-work information stored in advance in the storing section 32 (step S410). Subsequently, the usability-information generating section 44 repeatedly performs processing in steps S425 to S470 for each of one or more teaching points for work indicated by the teaching-point-for-work information read out in step S410 (step S420).

After the teaching point for work is selected in step S420, the usability-information generating section 44 reads out, from the storing section 32, redundant-degree-of-freedom-for-work information stored in advance in the storing section 32. The usability-information generating section 44 repeatedly performs the processing in steps S440 to S470 for each of one or more redundant degrees of freedom for work indicated by the read-out redundant-degree-of-freedom-for-work information (step S425).

The usability-information generating section 44 calculates, according to inverse kinematics, turning angles of the respective joints J11 to J17 in the case in which the first control point T1 is matched with the teaching point for work selected in step S420 and in the case in which the first redundant degree of freedom of the first arm is matched with the redundant degree of freedom for work selected in step S425 (step S440). Subsequently, the usability-information generating section 44 reads out the first arm information from the storing section 32. The usability-information generating section 44 converts, on the basis of the read-out first arm information and the turning angles calculated in step S440, the turning angles into the seven kinds of parameters (step S450).

Subsequently, the usability determining section 48 inputs the parameters calculated in step S450 into the support vector machine stored in the storing section 32 and causes the support vector machine to output information indicating which of possibility information indicating usability and possibility information indicating unusability is likely as possibility information associated with the first arm posture represented by the parameters. The usability determining section 48 determines, on the basis of the output, which of the usability and the unusability the possibility information associated with the first arm posture indicates (step S460). That is, the support vector machine is a function for outputting, when the parameters are input, information indicating which of possibility information indicating usability and possibility information indicating unusability is likely as possibility information associated with a first arm posture represented by the parameters.

Subsequently, the usability-information generating section 44 stores, in first usability information, information in which the possibility information based on a result of the determination performed in step S460, first arm position information indicating the position and the posture of the teaching point for work selected in step S420, a first arm position identification ID for identifying the first arm position information, and first redundant degree of freedom information associated with a first redundant degree of freedom identification ID for identifying first redundant degree of freedom information indicating the redundant degree of freedom for work selected in step S425 are associated. The first arm position identification ID is an ID that does not overlap other first arm position identification IDs in the first usability information. The first redundant degree of freedom identification ID is an ID that does not overlap other first redundant degree of freedom identification IDs in the first usability information. The usability-information generating section 44 shifts to step S425 and selects the next redundant degree of freedom for work. However, when an unselected redundant degree of freedom for work is absent in step S425, the usability-information generating section 44 shifts to step S420 and selects the next teaching point for work. However, when an unselected teaching point for work is absent in step S420, the robot control section 50 shifts to step S480.

After the repeated processing in steps S420 to S470 is performed, the robot control section 50 causes the robot 20 to perform the predetermined work on the basis of the operation program stored in advance in the storing section 32 and the teaching-point-for-work information and the first usability information stored in the storing section 32 (step S480) and ends the processing. Note that the processing in step S480 is the same processing as the processing in step S350 shown in FIG. 7. Therefore, explanation of the processing in step S480 is omitted.

In this way, the robot control device 30 moves the first arm, which includes seven or more axes, included in the robot 20 on the basis of the first usability information in which the usable first arm postures are determined among the plurality of first arm postures that the first arm can take when the first arm position coincides with the first target position serving as the target for changing the first arm position associated with the first arm. The robot control device 30 causes the robot 20 to perform the predetermined work. As a result, the robot control device 30 can move the first arm while matching the first arm posture of the robot 20 with the first arm posture desired by the user.

As explained above, the robot control device 30 moves an arm (in this example, the first arm), which includes seven or more axes, included in a robot (in this example, the robot 20) on the basis of usability information (in this example, the first usability information) in which usable arm postures are determined among a plurality of arm postures, (in this example, first arm postures) that the arm can take when an arm position (in this example, the first arm position) coincides with a target position (in this example, the first target position) serving as a target for changing the arm position associated with the arm. Consequently, the robot control device 30 can move the arm while matching an arm posture of the robot 20 with an arm posture desired by the user.

In the robot control device 30, the usability information is information in which possibility information indicating usability or unusability is associated with arm posture information (in this example, the first arm posture information) indicating each of the plurality of arm postures. Consequently, the robot control device 30 can move the arm while matching the arm posture of the robot 20 with the arm posture desired by the user on the basis of the usability information in which the possibility information indicating usability or unusability is associated with the arm posture information indicating each of the plurality of arm postures.

The robot control device 30 stores received arm posture information not included in the usability information in the usability information in association with received possibility information. Consequently, the robot control device 30 can move the arm while matching the arm posture of the robot 20 with the arm posture desired by the user on the basis of the received arm posture information and the received possibility information.

The robot control device 30 stores the arm posture information not included in the usability information in the usability information in association with possibility information associated with arm posture information indicating an arm posture that is closest to an arm posture indicated by the arm posture information and is included in the usability information. Consequently, the robot control device 30 can move the arm while matching the arm posture of the robot 20 with the arm posture desired by the user on the basis of the arm posture information indicating the arm posture closest to the arm posture indicated by the arm posture information not included in the usability information.

The robot control device 30 specifies likely possibility information as the possibility information associated with the arm posture indicated by the arm posture information not included in the usability information and stores the specified possibility information in the usability information in association with the arm posture information indicating the arm posture. Consequently, the robot control device 30 can move the arm while matching the arm posture of the robot 20 with the arm posture desired by the user on the basis of the likely possibility information specified as the possibility information associated with the arm posture indicated by the arm posture information not included in the usability information.

The robot control device 30 specifies, on the basis of one or more parameters (in this example, the six kinds of parameters) representing the arm posture indicated by the arm posture information not included in the usability information, likely possibility information as the possibility information associated with the arm posture. Consequently, the robot control device 30 can move the arm while matching the arm posture of the robot 20 with the arm posture desired by the user on the basis of the one or more parameters representing the arm posture indicated by the arm posture information not included in the usability information.

The embodiment of the invention is explained in detail above with reference to the drawings. However, the specific configuration is not limited to the embodiment and can be, for example, changed, replaced, or deleted without departing from the spirit of the invention.

It is also possible to record, in a computer-readable recording medium, a computer program for realizing functions of any components in the devices (e.g., the robot control device 30) explained above, cause a computer system to read the computer program, and execute the computer program. Note that the “computer system” includes an OS (an operating system) and hardware such as peripheral devices. The “computer-readable recording medium” refers to a portable medium such as a flexible disk, a magneto-optical disk, a ROM, or a CD (Compact Disk)-ROM or a storage device such as a hard disk incorporated in the computer system. Further, the “computer-readable recording medium” includes a recording medium that stores a computer program for a fixed time such as a volatile memory (a RAM) inside a computer system functioning as a server or a client when a computer program is transmitted via a network such as the Internet or a communication line such as a telephone line.

The computer program may be transmitted from a computer system, which stores the computer program in a storage device or the like, to another computer system via a transmission medium or by a transmission wave in the transmission medium. The “transmission medium”, which transmits the computer program, refers to a medium having a function of transmitting information like a network (a communication network) such as the Internet or a communication line (a communication wire) such as a telephone line.

The computer program may be a computer program for realizing a part of the functions explained above. Further, the computer program may be a computer program that can realize the functions in a combination with a computer program already recorded in the computer system, a so-called differential file (a differential program).

The entire disclosure of Japanese Patent Application No. 2016-187875, filed Sep. 27, 2016 is expressly incorporated by reference herein.

What is claimed is:

1. A robot control device comprising:
A processor that is configured to execute computer-executable instructions so as control a robot,
wherein the processor is configured to moves an arm the arm includes seven or more axes included in a robot, on the basis of usability information in which usable arm postures are determined among a plurality of arm postures that the arm can take when an arm position associated with the arm coincides with a target position serving as a target for changing the arm position.

2. The robot control device according to claim 1, wherein the usability information is information in which possibility information indicating usability or unusability is associated with arm posture information indicating each of the plurality of arm postures.

3. The robot control device according to claim 2,
Further comprising a memory:
wherein the memory stores the arm posture information received by the robot control device and not included in the usability information in the usability information in association with the possibility information received by the robot control device.

4. The robot control device according to claim 2, wherein the processor stores the arm posture information not included in the usability information in the usability information in association with the possibility information associated with the arm posture information that indicates the arm posture closest to the arm posture indicated by the arm posture information not included in the usability information and is included in the usability information.

5. The robot control device according to claim 2, wherein the processor specifies likely possibility information as the possibility information associated with the arm posture indicated by the arm posture information not included in the usability information and stores the specified possibility information in the usability information in association with the arm posture information indicating the arm posture.

6. The robot control device according to claim 5, wherein the processor specifies the likely possibility information on the basis of one or more parameters representing the arm posture indicated by the arm posture information not included in the usability information.

7. A robot controlled by the robot control device according to claim 1.

8. A robot controlled by the robot control device according to claim 2.

9. A robot controlled by the robot control device according to claim 3.

10. A robot controlled by the robot control device according to claim 4.

11. A robot controlled by the robot control device according to claim 5.

12. A robot controlled by the robot control device according to claim 6.

13. A robot system comprising:
the robot control device according to claim 1; and
the robot controlled by the robot control device.

14. A robot system comprising:
the robot control device according to claim 2; and
the robot controlled by the robot control device.

15. A robot system comprising:
the robot control device according to claim 3; and
the robot controlled by the robot control device.

16. A robot system comprising:
the robot control device according to claim 4; and
the robot controlled by the robot control device.

17. A robot system comprising:
the robot control device according to claim 5; and
the robot controlled by the robot control device.

18. A robot system comprising:
the robot control device according to claim 6; and
the robot controlled by the robot control device.
